(19) United States
(12) Patent Application Publication
(10) Pub. No.: US 2025/0270043 A1
(43) Pub. Date: Aug. 28, 2025

(54) METHODS FOR MANAGING LOADS IN STORAGE FACILITIES USING DISTRIBUTED ROBOTS

(71) Applicant: ILLUMINIFY TECHNOLOGIES PRIVATE LIMITED, Banglore (IN)

(72) Inventors: Pranav Srinivasan, Chennai (IN); Tuhin Sharma, Bangalore (IN); Arjun Balakishnan, Bangalore (IN); Christuraj Vipin Raj, Kanyakumari (IN)

(73) Assignee: ILLUMINIFY TECHNOLOGIES PRIVATE LIMITED, Banglore (IN)

(21) Appl. No.: 19/062,354

(22) Filed: Feb. 25, 2025

(30) Foreign Application Priority Data
Feb. 27, 2024 (IN) 202441014260

(51) Int. Cl. B65G 1/137; G05D 1/646; G05D 1/661; G05D 1/667; G05D 1/69; G05D 105/20; G05D 107/70; G05D 109/15; G05D 111/10; G05D 111/20

(52) U.S. Cl. CPC B65G 1/137; G05D 1/646; G05D 1/661; G05D 1/667; G05D 1/69; B65G 2203/0258; B65G 2203/041; B65G 2203/044; G05D 2105/20; G05D 2107/70; G05D 2109/15; G05D 2111/17; G05D 2111/20

(57) ABSTRACT

Disclosed is a system for managing loads in a storage facility. The system comprises: a racking structure configured to store loads; mobile robot assembly(ies) (MRA(s)) operable to traverse within a storage facility, wherein MRA(s) comprises a mobile robot and a docking arrangement; and pick and drop robots (PDRs) operable to traverse along a height of storage facility for picking and dropping loads from racking structure, wherein PDRs comprise a latch arrangement and climb arrangement. Herein, MRA is operable to carry a PDR from amongst PDRs, PDR being operatively mounted on docking arrangement of MRA, wherein when MRA is at a first predefined distance from racking structure, PDR engages itself to racking structure via latch arrangement, and climb arrangement is configured to extend or retract vertically along a length of racking structure, for picking and dropping loads from racking structure upon engagement with racking structure.

### CROSS-REFERENCE TO RELATED APPLICATIONS/INCORPORATION BY Reference

This Application makes reference to, claims priority to, and claims benefit from Indian Provisional Application No. 202441014260 filed on Feb. 27, 2024.

The above-referenced Applications are hereby incorporated herein by reference in their entirety.

### TECHNICAL FIELD

The present disclosure relates to systems for managing loads in a storage facility. The present disclosure also relates to methods for managing loads in a storage facility.

### BACKGROUND

Presently, in storage facilities such as warehouses, various types of goods storage and retrieval systems and methods are employed to store and retrieve loads (for example, such as totes). Several of such systems employ autonomous mobile robots, which navigate through storage racks of the storage facility to perform tote storage and tote retrieval functions.

However, existing systems for goods storage and retrieval have several limitations. Firstly, their installation into existing storage facilities is sometimes not feasible infrastructurally, or if feasible, the installation is very expensive and/or cumbersome. Secondly, throughput (i.e., number of storage tasks and retrieval tasks) of such systems is quite limited, due to one or more factors such as, construction and design of mobile robots, limited autonomous functionality in mother-child robot systems, limited range of movement of mobile robots, and the like. Thirdly, the existing mother-child robot systems are designed such that the mother unit is unable to navigate while its child unit performs the storage/retrieval tasks. This leads to wastage of time, and navigation issues within the storage facility.

Therefore, in light of the foregoing discussion, there exists a need to overcome the aforementioned drawbacks.

### SUMMARY

The present disclosure seeks to provide a system for managing loads in a storage facility. The present disclosure also seeks to provide a method for system for managing loads in a storage facility. An aim of the present disclosure is to provide a solution that overcomes at least partially the problems encountered in prior art.

In one aspect, an embodiment of the present disclosure provides A system for managing loads in a storage facility, the system comprising:
a racking structure configured to store the loads;
at least one mobile robot assembly operable to traverse within a storage facility, each of the at least one mobile robot assembly comprising:
   a mobile robot; and
   a docking arrangement; and
a plurality of pick and drop robots operable to traverse along a height of the storage facility for picking and dropping the loads from the racking structure, each of the pick and drop robots comprising:
   a latch arrangement; and
   climb arrangement,
      wherein the at least one mobile robot assembly is operable to carry a pick and drop robot from amongst the plurality of pick and drop robots, the pick and drop robot being operatively mounted on the docking arrangement of the at least one mobile robot assembly, wherein when the at least one mobile robot assembly is at a first predefined distance from the racking structure, the pick and drop robot engages itself to the racking structure via the latch arrangement, and the climb arrangement is configured to extend or retract vertically along a length of the racking structure, for picking and dropping the loads from the racking structure upon engagement with the racking structure.

Optionally, the racking structure comprises:
a first rack comprising:
   a plurality of first pillars that are arranged in a rectangular configuration to form a storage space, and
   a plurality of first plates mounted between the plurality of first pillars to form storage compartments in the storage space, wherein the plurality of first plates are configured to support the loads for the storage thereof, and wherein each of the plurality of first plates are stacked on top of each other at a second predefined distance from each other; and
a second rack comprising:
   a plurality of second pillars that are arranged in rectangular configuration to form another storage space, and
   a plurality of second plates mounted between the plurality of second pillars to form storage compartments in the another storage space, the plurality of second plates are configured to support the loads for the storage thereof, and wherein each of the plurality of second plates are stacked on top of each other at a third predefined distance from each other;
      wherein at least two first pillars from amongst the plurality of first pillars of the first rack that face towards corresponding at least two second pillars from amongst the plurality of second pillars of the second rack, are arranged at a predefined distance from each other to form aisles for the at least one mobile robot assembly to traverse and carry the pick and drop robot therealong.

Optionally, the racking structure further comprises:
a plurality of first rack gears coupled to the plurality of first pillars of the first rack; and
a plurality of second rack gears coupled to the plurality of second pillars of the second rack,
   wherein the plurality of first rack gears and the plurality of second rack gears form paths for the plurality of pick and drop robots to traverse vertically along the racking structure.

Optionally, each of the at least one mobile robot assembly comprises:
a traction arrangement having:
   a chassis,
   a plurality of wheels mounted on the chassis, and
   one or more drive motors operatively coupled with the plurality of wheels,
   a transmission mechanism for operatively coupling the one or more drive motors with the plurality of wheels;
a suspension mechanism mounted on the chassis;
a power source mounted on the chassis and operatively coupled to the one or more drive motors;
a first controller for controlling power from the power source to the one or more drive motors of the traction arrangement for traversing the at least one mobile robot assembly to a designated location in the storage facility; and
a traverse controlling unit operatively coupled to the first controller, wherein said traverse controlling unit is operable to determine and control movement of the at least one mobile robot assembly within the storage facility.

Optionally, the traverse controlling unit comprises at least one of:
a camera operatively coupled to the first controller, wherein the camera is operable to capture at least one image of a plurality of reading tags arranged on a floor of the storage facility to determine a position and an orientation of the at least one mobile robot assembly with respect to the storage facility;
an ultrasonic sensor operatively coupled to the first controller, wherein the ultrasonic sensor is operable to measure distance to at least one obstacle within the storage facility to determine a position and an orientation of the at least one mobile robot assembly with respect to the storage facility;
a light detection and ranging (LIDAR) operatively coupled to the first controller, the LIDAR is operable to emit laser beam for creating a three-dimensional (3D) map to detect and interact with surrounding objects of the at least one mobile robot assembly while traversing.

Optionally, the at least one mobile robot assembly further comprises a guidance system that is operatively coupled with the first controller, wherein the first controller is configured to:
receive input from the guidance system, wherein the input comprises position values of the at least one mobile robot assembly;
process the input to determine any deviation of the at least one mobile robot assembly from a predefined path;
when it is determined that there is a deviation of the at least one mobile robot assembly from a predefined path, generate and send at least one control signal to keep the at least one mobile robot assembly in the predefined path, based on the deviation, wherein the at least one control signal comprises instructions for keeping the at least one mobile robot assembly in the predefined path; and
transmit the at least one control signal to the traverse controlling unit to execute the instructions to keep the at least one mobile robot assembly in the predefined path.

Optionally, the climb arrangement comprises a first pinion at a first end, and a second pinion at a second end opposite to the first end, wherein the first end of the first pinion is coupled with a bevel gearbox using a universal coupler, and the second end of the second pinion is coupled directly with the bevel gearbox.

Optionally, the docking arrangement comprises at least two discs with a predefined gap between each other, wherein each of the plurality of pick and drop robots comprises a corresponding guide rail and plate that is arranged in said predefined gap to operatively mount the pick and drop robot on the docking arrangement of the at least one mobile robot assembly.

Optionally, each of the plurality of pick and drop robots comprises:
a chassis having a plurality of frame members;
a power source mounted on the chassis;
a plurality of first compliance units and a plurality of second compliance units coupled with the chassis and operable to engage with the plurality of first rack gears and the plurality of second rack gears, respectively;
a power transmission mechanism, operatively coupled to the plurality of first compliance units and the plurality of second compliance units, for providing transmission power to the plurality of first compliance units and a plurality of second compliance units to traverse along the plurality of first rack gears and the plurality of second rack gears, respectively;
a fork mechanism mounted on the chassis and operable to pick and drop the loads from the racking structure, wherein the fork mechanism has a third end and a fourth end opposite to the third end; and
a second controller, operatively coupled with the power source, the power transmission mechanism and the fork mechanism, for traversing each of the plurality of pick and drop robots to a given storage compartment in the storage facility for picking and dropping the loads therefrom.

Optionally, the power transmission mechanism comprises:
a pair of motors; and
a pair of bevel gearboxes operatively coupled with the pair of motors, and wherein each of the plurality of compliance units comprises:
a drive shaft operatively coupled with one of the pair of bevel gearboxes;
a pinion gear operatively coupled with the drive shaft;
a spring-loaded guide rail mounted on one of a frame member of the chassis, wherein the spring-loaded guide rail is arranged longitudinally between the third end and the fourth end of the fork mechanism; and
a pair of gear fixator for supporting the pinion gear on the spring loaded guide rail.

Optionally, the fork mechanism comprises:
a grappling hook mechanism configured to pull the load and traverse along the spring-loaded guide rail;
at least two receiving elements arranged longitudinally on either side of the spring-loaded guide rail between the third and the fourth end, to receive the loads when pulled by the grappling hook mechanism; and
at least two proximity sensors arranged on the third end and the fourth end of the fork mechanism, wherein the at least two proximity sensors emulate safety endstops for the grappling hook mechanism when traversing along the spring-loaded guide rail.

Optionally, the grappling hook mechanism comprises:
a first hook element having a fifth end and a sixth end opposite to the fifth end, wherein the fifth end of the first hook element has a first extended element for pulling the load from a storage compartment in the racking structure onto the pick and drop robot till a first predefined endstop, said first hook element has a first predefined length from the fifth end to the sixth end;
a second hook element having a seventh end and an eighth end opposite to the seventh end, wherein the eighth end of the second hook element has a second extended element for pulling the load till a second predefined endstop of at least two receiving elements, said second hook element has a second predefined length from the seventh end to the eighth end, wherein the second predefined length is lesser than the first predefined length, and wherein the sixth end of the first hook element is joined perpendicularly with the seventh end of the second hook element; and
a motor that is configured to rotate between the first hook element and the second hook element.

Optionally, the grappling hook mechanism further comprises:
a first sensor arranged on the first hook element; and
a second sensor arranged on the second hook element,
   wherein the first sensor and the second sensor are configured to determine at least one of: a position of the load on the fork mechanism, a distance of the load from the fifth end of the first hook element and/or the eighth end of the second hook element.

Optionally, the fork mechanism further comprises a third sensor that is configured to identify overhanging of the load from a storage compartment of the racking structure, in a path of the pick and drop robot, when the pick and drop robot is traversing vertically along the racking structure.

Optionally, each of the plurality of pick and drop robots further comprises a load cell to measure a weight of a given load picked by the fork mechanism, wherein the fork mechanism is arranged on the load cell.

Optionally, the docking arrangement further comprises:
a plurality of first aligner flanges and stoppers mounted on the plurality of first pillars, and adjacent to the plurality of first rack gears; and
a plurality of second aligner flanges and stoppers mounted on the plurality of second pillars, and adjacent to the plurality of second rack gears;
   wherein the plurality of first aligner flanges and stoppers and the plurality of second aligner flanges and stoppers are configured to align position of the pinion gear with respect to the plurality of first rack gears and the plurality of second rack gears by pressing the spring-loaded guide rail and thereby engaging and retaining movement of the pinion gear with the plurality of first rack gears and plurality of second rack gears.

Optionally, the system further comprises a fourth sensor for sensing a position of the pinion gear with respect to the plurality of first rack gears and the plurality of second rack gears to allow the power transmission mechanism to operate and allow movement of the pinion gear with respect to the plurality of first rack gears and the plurality of second rack gears.

In a second aspect, the present disclosure provides a method for managing loads in a storage facility, the method comprising:
carrying a pick and drop robot from amongst a plurality of pick and drop robots by at least one mobile robot assembly that is operable to traverse within a storage facility, wherein the pick and drop robot is operatively mounted on a docking arrangement of said at least one mobile robot assembly;
when the at least one mobile robot assembly is at a first predefined distance from a racking structure, engaging the pick and drop robot to the racking structure via a latch arrangement of the pick and drop robot; and
when the pick and drop robot is engaged with the racking structure, extending or retracting the pick and drop robot along a length of the racking structure, via a climb arrangement, for picking and dropping the loads from the racking structure.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1A illustrates a block diagram of a system for managing loads in a storage facility, in accordance with an embodiment of the present disclosure;

FIGS. 1B, 1C, 1D, and 1E show different views of the mobile robot assembly, in accordance with an embodiment of the present disclosure;

FIGS. 1F, and 1G show different views of the pick and drop robot, in accordance with an embodiment of the present disclosure;

FIG. 1H shows a top view of the latch arrangement, in accordance with an embodiment of the present disclosure;

FIG. 1I shows a schematic illustration of the racking structure, in accordance with an embodiment of the present disclosure;

FIG. 1J shows docking of the pick and drop robot with the mobile robot assembly, in accordance with an embodiment of the present disclosure;

FIG. 2 shows a pinion gear of the power transmission mechanism, in accordance with an embodiment of the present disclosure;

FIG. 3 shows a traction arrangement of mobile robot assembly of FIG. 1A, in accordance with an embodiment of the present disclosure;

FIGS. 4A, 4B, 4C, and 4D, show schematic illustrations, in different views, of the fork mechanism, in accordance with an embodiment of the present disclosure;

FIG. 5 shows a grappling hook mechanism, in accordance with an embodiment of the present disclosure;

FIG. 6 shows a schematic illustration of a pick and drop robot, in accordance with an embodiment of the present disclosure; and

FIG. 7 illustrates steps of a method for managing loads in a storage facility, in accordance with an embodiment of the present disclosure.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

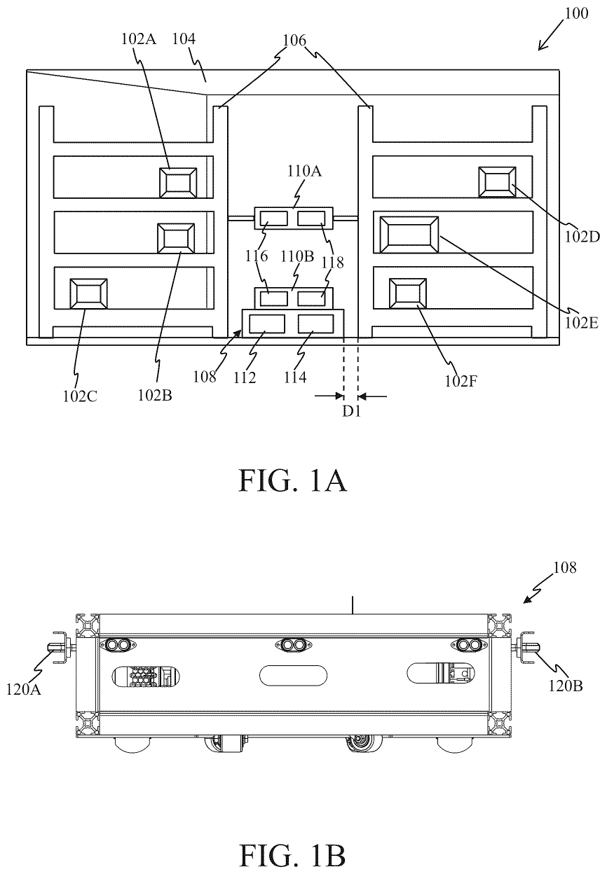

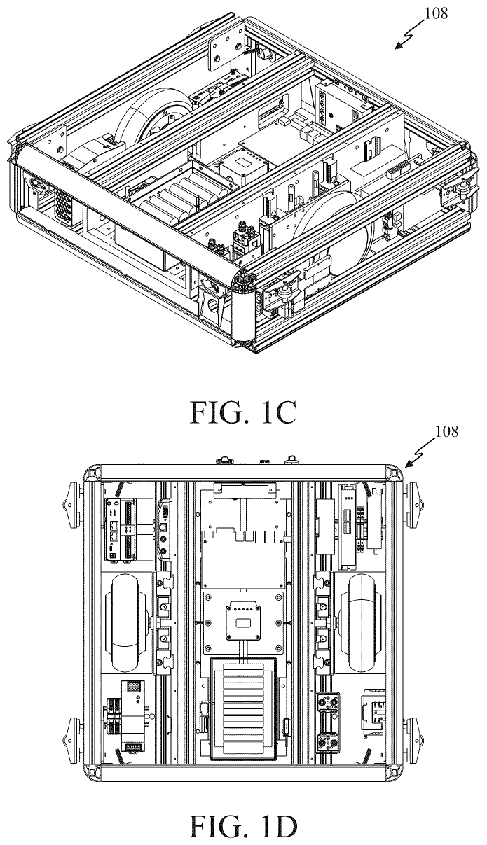

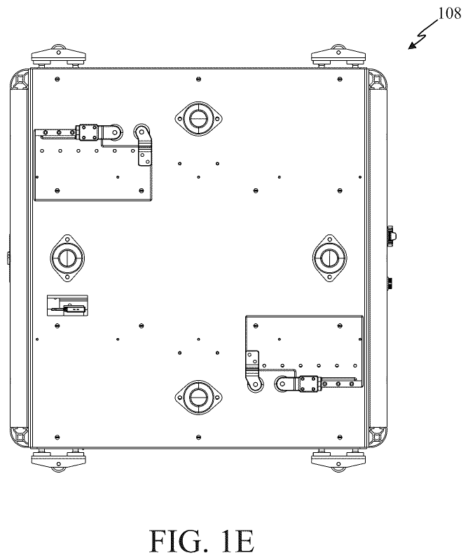

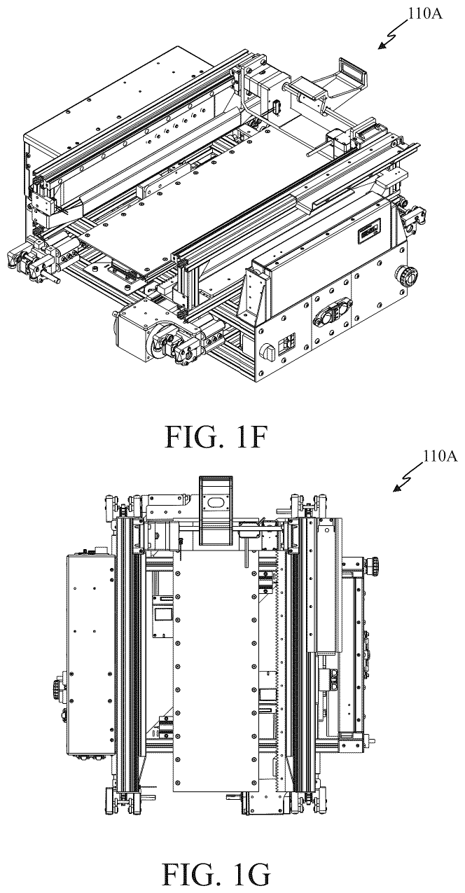

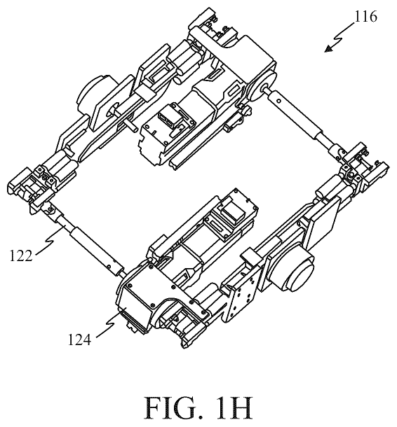

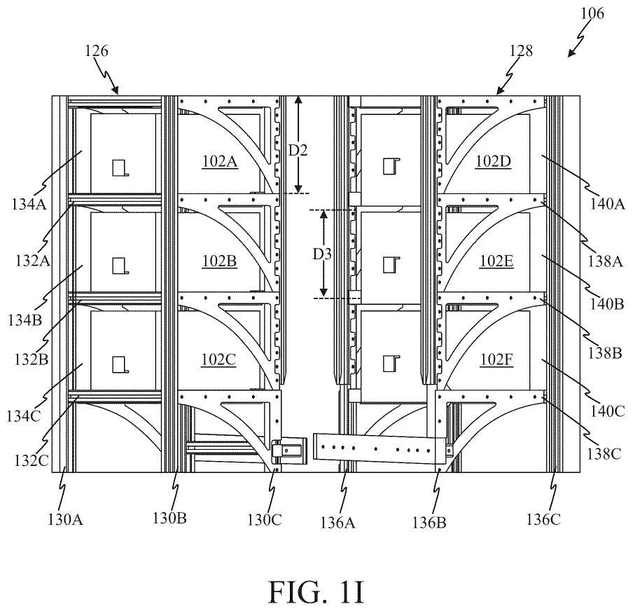

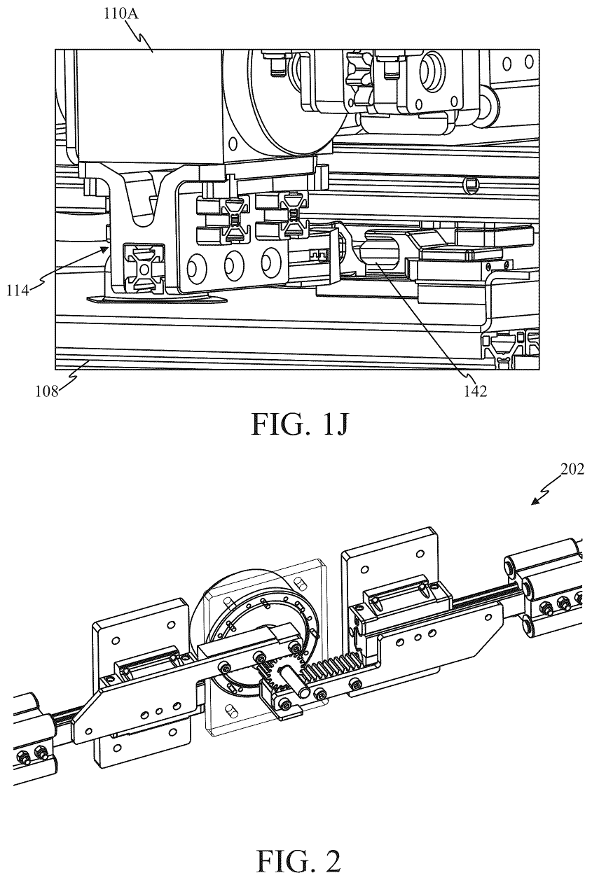

Referring to FIG. 1A, there is illustrated a block diagram of a system 100 for managing loads (depicted as loads 102A, 102B, 102C, 102D, 102E, and 102F) in a storage facility 104, in accordance with an embodiment of the present disclosure. The system 100 comprises a racking structure 106 configured to store the loads 102A-F, at least one mobile robot assembly (depicted as a mobile robot assembly 108) to traverse within a storage facility 104, a plurality of pick and drop robots (depicted as two pick and drop robots 110A and 110B) operable to traverse along a height of the storage facility 104 for picking and dropping the loads 102A-F from the racking structure 106. The mobile robot assembly 108 comprises a mobile robot 112, and a docking arrangement 114. Each of the two pick and drop robots 110A-B comprises a latch arrangement 116, and a climb arrangement 118. Herein, the mobile robot assembly 108 is operable to carry a pick and drop robot 110A from amongst the two pick and drop robots 110A-B, the pick and drop robot 110A being operatively mounted on the docking arrangement 114 of the mobile robot assembly 108, wherein when the mobile robot assembly 108 is at a first predefined distance D1 from the racking structure 106, the pick and drop robot 110A engages itself to the racking structure 106 via the latch arrangement 116, and the climb arrangement 118 is configured to extend or retract vertically along a length of the racking structure 106, for picking and dropping the loads 102A-F from the racking structure 106 upon engagement with the racking structure 106.

Referring to FIGS. 1B, 1C, 1D and 1E, there are shown different views of the mobile robot assembly 108, in accordance with an embodiment of the present disclosure. In FIGS. 1B and 1E, there are shown external view of the mobile robot assembly 108. In FIGS. 1C and 1D, there are shown internal view mobile robot assembly 108. In FIG. 1B, there is shown a front view of the mobile robot assembly 108. The mobile robot assembly 108 optionally comprises a guidance system (depicted as guides 120A and 120B). In FIG. 1C, there is shown an isometric view of the mobile robot assembly 108. In FIG. 1D, there is shown a top view of the mobile robot assembly 108. In FIG. 1E, there is shown a top view of the mobile robot assembly 108.

Referring to FIGs. IF and 1G, there are shown different views of the pick and drop robot 110A, in accordance with an embodiment of the present disclosure. In FIG. 1F, there is shown an isometric view of the pick and drop robot 110A. In FIG. 1G, there is shown a top view of the pick and drop robot 110A.

Referring to FIG. 1H, there is shown a top view of the latch arrangement 116, in accordance with an embodiment of the present disclosure. Optionally, the latch arrangement 116 comprises a universal coupler 122 and direct coupler 124. In this regard, a first end of a first pinion of the climb arrangement 118 is coupled with a bevel gearbox using the universal coupler 122, and a second end of a second pinion of the climb arrangement 118 is coupled directly with the bevel gearbox, via the direct coupler 124.

Referring to FIG. 1I, there is shown a schematic illustration of the racking structure 106, in accordance with an embodiment of the present disclosure. The racking structure 106, optionally, comprises a first rack 126 and a second rack 128. The first rack 126 comprises a plurality of first pillars (depicted as first pillars 130A, 130B, 130C) that are arranged in a rectangular configuration to form a storage space, and a plurality of first plates (depicted as first plates 132A, 132B, 132C) mounted between the first pillars 130A-C to form storage compartments 134A, 134B, and 134C in the storage space, wherein the first plates 132A-C are configured to support the loads 102A-C for the storage thereof, and wherein first plates 132A-C are stacked on top of each other at a second predefined distance D2 from each other. Moreover, the second rack 128 comprises a plurality of second pillars (depicted as second pillars 136A, 136B, 136C) that are arranged in rectangular configuration to form another storage space, and a plurality of second plates (depicted as second plates 138A, 138B, 138C) mounted between the second pillars 136A-C to form storage compartments 140A, 140B, and 140C in the another storage space, the second plates 138A-C are configured to support the loads 102D-F for the storage thereof, and wherein the second plates 138A-C are stacked on top of each other at a third predefined distance D3 from each other.

Referring to FIG. 1J, there is shown docking of the pick and drop robot 110A with the mobile robot assembly 108, in accordance with an embodiment of the present disclosure. In this regard, the docking arrangement 114 is responsible for docking of the pick and drop robot 110A with the mobile robot assembly 108. The docking arrangement 114 comprises at least two discs (depicted as a disc 142 that is visible in the FIG. 1J) with a predefined gap between each other, wherein the pick and drop robot 110A comprises a corresponding guide rail and plate that is arranged in said predefined gap to operatively mount the pick and drop robot 110A on the docking arrangement 114 of the mobile robot assembly 108.

It may be understood by a person skilled in the art that the FIGS. 1A-J includes a simplified architecture of a system 100 for sake of clarity, which should not unduly limit the scope of the claims herein. The person skilled in the art will recognize many variations, alternatives, and modifications of embodiments of the present disclosure.

The system 100 is an integrated assembly of components designed to facilitate the handling, movement, and storage of the loads 102A-F within the storage facility 104. The system 100 includes both fixed component, i.e., a structural component (for example, the racking structure 106) and mobile component, i.e., robotic component (for example, the mobile robot assembly 108, and the pick and drop robots 110A-B) that work in coordination to transport, store, retrieve, and relocate the loads 102A-F efficiently. Herein, the loads 102A-F are organized using the racking structure 106, which provides designated storage locations for the loads 102A-F. Beneficially, the system 100 enables automated load management, which enhances efficiency, by allowing dynamic and on-demand retrieval and storage of the loads 102A-F. Such retrieval and storage of the loads 102A-F minimizes downtime and increases throughput.

Throughout the present disclosure, the term “storage facility” refers to any structure or area, which is designed and used for a purpose of holding, stockpiling, or warehousing goods, materials, or items. The storage facility 104 could be enclosed or open. Examples of the storage facility 104 may include, but are not limited to, a warehouse (for example, a standard warehouse, a non-standard warehouse), a distribution center, a storage yard, a shelving system, the racking structure 106, and a designated area within a larger structure.

Throughout the present disclosure, the term “load” refers to any unit of goods, materials, or items, that are any one of: stored, handled, managed, within the storage facility 104. The term “load” encompasses namely, a bin, a tote, a payload. Examples of a load may include, but are not limited to, an individual item (for example, such as a single product, a component), a packaged good (for example, such as a box, a carton, a pallet), a bulk material (for example, such as liquid, powders, grains), and a collections of items (for example, such as containers, unit loads).

Throughout the present disclosure, the term “racking structure” refers to a fixed framework of interconnected beams, shelves, and supports that provide designated slots or compartments for storing loads 102A-F within the storage facility 104. The racking structure 106 is reinforced to support the weight of stored items and to withstand dynamic forces from robotic operations. The racking structure 106 includes guides, rails, or gear tracks to facilitate the engagement and movement of the pick and drop robots 110A-B. Moreover, the racking structure 106 allows vertical and horizontal loading of the loads 102A-F. The racking structure 106 is reinforced to support a weight of the loads 102A-F and to withstand dynamic forces from robotic operations of the pick and drop robots 110A-B. An example of the racking structure 106 may be a Module 3 racking structure. A technical benefit of the racking structure 106 is that it allows access to loads 102A-F without requiring human intervention. Moreover, such racking structure 106 also provides predictable, structured storage, which enhances operational efficiency of the at least one mobile assembly and the pick and drop robots 110A-B.

Optionally, the racking structure 106 comprises:
a first rack 126 comprising:
a plurality of first pillars 130A-C that are arranged in a rectangular configuration to form a storage space, and
a plurality of first plates 132A-C mounted between the plurality of first pillars 130A-C to form storage compartments 134A-C in the storage space, wherein the plurality of first plates 132A-C are configured to support the loads 102A-F for the storage thereof, and wherein each of the plurality of first plates 132A-C are stacked on top of each other at a second predefined distance D2 from each other; and a second rack 128 comprising:
a plurality of second pillars 136A-C that are arranged in rectangular configuration to form another storage space, and
a plurality of second plates 138A-C mounted between the plurality of second pillars 136A-C to form storage compartments 140A-C in the another storage space, the plurality of second plates 138A-C are configured to support the loads 102A-F for the storage thereof, and wherein each of the plurality of second plates 138A-C are stacked on top of each other at a third predefined distance D3 from each other;
   wherein at least two first pillars from amongst the plurality of first pillars 130A-C of the first rack 126 that face towards corresponding at least two second pillars 136A-C from amongst the plurality of second pillars 136A-C of the second rack 128, are arranged at a predefined distance from each other to form aisles for the mobile robot assembly 108 to traverse and carry the pick and drop robot 110A-B therealong.

A technical effect of the first rack 126 and the second rack 128 is that it ensures efficient automated storage and retrieval operations.

Herein, the racking structure 106 comprises two separate racks, i.e., the first rack 126 and the second rack 128 that are structurally independent but spatially coordinated with each other. In this regard, the first rack 126 is a modular storage structure that provides a set of organized storage compartments 134A-C, formed by plurality of first pillars 130A-C and plurality of first plates 132A-C. Similarly, the second rack 128 is a modular storage structure that provides a set of organized storage compartments 140A-C, formed by the plurality of second pillars 136A-C and the plurality of second plates 138A-C. Herein, the first rack 126 and the second rack 128 align with each other to form the aisles for traversal of the mobile robot assembly 108.

Moreover, the plurality of first pillars 130A-C are vertical load-bearing members that provide structural stability to the first rack 126. The plurality of first pillars 130A-C form a primary skeletal framework of the racking structure 106. The plurality of first pillars 130A-C are arranged in the rectangular configuration, that means they form a box-like perimeter structure with a defined width, height, and depth. Such rectangular configuration ensures even load distribution, thus reducing structural stress. Additionally, the rectangular configuration provides modularity, allowing scalability for different storage capacities. Moreover, such rectangular configuration provides modularity, thus allowing scalability for different storage capacities.

Moreover, the plurality of first plates 132A-C are horizontal load-bearing elements that segment the storage facility 104 into discrete compartments for placing the loads 102A-C. Each of the plurality of first plates 132A-C are fixed or mounted between adjacent first pillars 130A-C, thus effectively dividing the vertical space into multiple levels. Herein, the plurality of first plates 132A-C support loads 102A-C directly, thereby preventing unwanted displacement of the loads 102A-C. Each of the plurality of first plates 132A-C are stacked on top of each other at the second predefined distance D2 from each other, wherein the term “second predefined distance” refers to the fixed spacing between consecutive first plates 132A-C. Stacking each of the plurality of first plates 132A-C at the second predefined distance D2 ensures uniform storage compartment sizing. Additionally, such stacking also optimizes load accessibility for retrieval. It will be appreciated that the plurality of first plates 132A-C are manufactured with materials that are capable of handling loads 102A-C of predefined weight limits. An example of predefined weight limit of the load may be 30 kilograms (kg)) within a predefined dimension (for example, such as 600 units (in length)*400 units (in weight)*425 units (in height).

It will be appreciated that the second rack 128 is structurally identical to the first rack 126, providing another independent storage space. The second rack 128 provides additional structured storage, thus increasing capacity of the storage facility 104. The second rack 128 works in coordination with the first rack 126 to define the aisles for navigation of the mobile robot assembly 108. Herein, the term “aisles” refers to defined spaces between the first rack 126 and second rack 128, that allows for movement of the mobile robot assembly 108 within the storage facility 104. In this regard, the predefined distance is maintained between opposing first and second pillars 136A-C to create clear passageways. This predefined distance allows the mobile robot assembly 108 to navigate while carrying a given pick and drop robot (namely, a pick and drop robot, a child robot). A technical effect of forming the aisles is that it facilitates autonomous navigation of the mobile robot assembly 108, thus reducing operational inefficiencies.

Moreover, the plurality of second pillars 136A-C are also vertical load-bearing members that provide structural stability to the second rack 128. The plurality of second pillars 136A-C also form a primary skeletal framework of the racking structure 106. The plurality of second pillars 136A-C are arranged in the rectangular configuration, that means they form a box-like perimeter structure with a defined width, height, and depth. Herein, dimensions of the plurality of second pillars 136A-C may or may not be similar to dimensions of the plurality of first pillars 130A-C.

Moreover, the plurality of second plates 138A-C are also horizontal load-bearing elements that segment the storage facility 104 into discrete compartments for placing the loads 102D-F. Each of the plurality of second plates 138A-C are fixed or mounted between adjacent second pillars 136A-C, thus effectively dividing the vertical space into multiple levels. Herein, the plurality of second plates 138A-C support loads 102D-F directly, thereby preventing unwanted displacement of the loads 102D-F. Each of the plurality of second plates 138A-C are stacked on top of each other at the third predefined distance D3 from each other, wherein the term “third predefined distance” refers to the fixed spacing between consecutive second plates 138A-C. Stacking each of the plurality of second plates 138A-C at the third predefined distance D3 ensures uniform storage compartment sizing. Additionally, such stacking also optimizes load accessibility for retrieval. It will be appreciated that the plurality of second plates 138A-C are manufactured with materials that are capable of handling loads 102D-F of predefined weight limits, similar to the manufacturing of the plurality of first plates 132A-C.

Optionally, the racking structure 106 further comprises:
a plurality of first rack gears coupled to the plurality of first pillars 130A-C of the first rack 126; and
a plurality of second rack gears coupled to the plurality of second pillars 136A-C of the second rack 128,
wherein the plurality of first rack gears and the plurality of second rack gears form paths for the plurality of pick and drop robots 110A-B to traverse vertically along the racking structure 106.

Herein, the term “rack gear” refers to toothed components that are mechanically coupled to the plurality of first pillars 130A-C of the first rack 126 and/or the plurality of second pillars 136A-C of the second rack 128. Herein, the rack gear serves as engagement interfaces for gear-driven climbing mechanisms of the pick and drop robots 110A-B.

Moreover, the plurality of first rack gears are rigidly mounted or integrated along the length of the plurality of first pillars 130A-C. The plurality of first rack gears could be mechanically coupled with the plurality of first pillars 130A-C by way of any one of: bolted configuration, welded configuration, interlocked configuration. Each of the plurality of first rack gears is positioned to align with corresponding drive systems of the pick and drop robots 110A-B, thus ensuring smooth mechanical engagement.

Moreover, the plurality of second rack gears are mechanically identical to the plurality of first rack gears, but the plurality of second rack gears are mounted on the plurality of second pillars 136A-C of the second rack 128. The plurality of second rack gears provide an alternative engagement path for the pick and drop robots 110A-B, thus allowing climbing along the second rack 128. Similar to the plurality of first rack gears, the plurality of second rack gears are securely affixed along a length of the second pillars 136A-C using precise alignment mechanisms. The mounting ensures that the pick and drop robots 110A-B can engage with either the plurality of first rack gears or the plurality of second rack gears, thus providing flexibility in storage access.

Moreover, the plurality of first rack gears and the plurality of second rack gears form paths for the pick and drop robots 110A-B to traverse vertically along the racking structure 106, wherein the term “paths” refer to the defined movement trajectories that the pick and drop robots 110A-B follow while moving vertically along the racking structure 106. These paths are formed by the aligned plurality of first rack gears and the plurality of second rack gears, which provide mechanical engagement surfaces for climbing. In this regard, the plurality of first rack gears and the plurality of second rack gears act as linear guides along which the given pick and drop robot ascends or descends. A technical benefit of the plurality of first rack gears and the plurality of second rack gears forming such paths is that it provides direct mechanical engagement, thereby ensuring high-precision movement.

A technical effect of the plurality of first rack gears and the plurality of second rack gears is that it enables vertical traversal of the pick and drop robots 110A-B, thus allowing them to access the loads 102A-F at different storage levels.

Throughout the present disclosure, the term “mobile robot assembly” refers to an autonomous or a semi-autonomous robotic unit designed to navigate the storage facility 104, carrying and positioning the pick and drop robots 110A-B or loads 102A-F as required. The mobile robot 112 is responsible for locomotion, and transportation of each of the pick and drop robots 110A-B, wherein the pick and drop robots 110A-B could or could not carry a given load. Moreover, the term “docking arrangement” refers to a mechanical interface provided on the mobile robot assembly 108, that is designed for secure attachment and transport of pick and drop robots 110A-B. The mobile robot assembly 108 traverses the storage facility 104 by using any one of: a wheeled drive mechanism, a tracked drive mechanism, an omnidirectional drive mechanism. Moreover, the mobile robot assembly 108 could employ a sensor for autonomous navigation and obstacle avoidance. Examples of the sensor may include, but are not limited to, LIDAR, vision cameras, and Inertial Measurement Units (IMUs). Furthermore, the mobile robot assembly 108 could utilize wireless communication (for example, such as Wi-Fi, RFID, and similar) to coordinate with warehouse management systems. Beneficially, the mobile robot assembly 108 enables flexible and dynamic transport of the pick and drop robots 110A-B to different locations. Moreover, there is reduction of dependency on infrastructure of the storage facility 104 by eliminating a need for fixed conveyors or overhead cranes. Additionally, the mobile robot assembly 108 can drop a given pick and drop robot, and pick another given pick and drop robot while the given pick and drop robot is picking or dropping the load. This allows on-demand dispatching to different zones of the storage facility 104 based on real-time requirements. The mobile robot assembly 108 comprises at least one key specification, wherein the at least one key specification comprises at least one of: a dimension of the mobile robot 112, a turning diameter, a suspension type, a direction of travel, a navigation type, a gearbox type. A technical benefit of the mobile robot assembly 108 is that it enhances scalability, as multiple mobile robots and the pick and drop robots 110A-B, can operate in parallel, thus increasing efficiency and adaptability.

Optionally, the at least one mobile robot assembly 108 further comprises a guidance system 120A-B that is operatively coupled with the first controller, wherein the first controller is configured to:
receive input from the guidance system 120A-B, wherein the input comprises position values of the at least one mobile robot assembly 108;
process the input to determine any deviation of the at least one mobile robot assembly 108 from a predefined path;
when it is determined that there is a deviation of the at least one mobile robot assembly 108 from a predefined path, generate and send at least one control signal to keep the at least one mobile robot assembly 108 in the predefined path, based on the deviation, wherein the at least one control signal comprises instructions for keeping the at least one mobile robot assembly 108 in the predefined path; and
transmit the at least one control signal to the traverse controlling unit to execute the instructions to keep the at least one mobile robot assembly 108 in the predefined path.

Herein, the term “guidance system” refers to a subsystem within the 108 that provides positioning and navigation data to ensure that the mobile robot assembly 108 follows the predefined path. In other words, the guidance system 120A-B allows the mobile robot assembly 108 to course correct when upon entering the aisle of the storage facility 104. In this regard, the guidance system 120A-B detects a real-time position of the mobile robot assembly 108, wherein the input is received from the sensors, for example, such as the camera, the ultrasonic sensors, the LIDAR, the inertial measurement units (IMUs), and similar. The guidance system 120A-B continuously feeds the position values of the mobile robot assembly 108 to the first controller to compare the actual movement of the mobile robot assembly 108 against the predefined path. Herein, the term “predefined path” refers to a pre-calculated trajectory that the mobile robot assembly 108 must follow to navigate within the storage facility 104. In other words, the first controller compares a current position value from the guidance system 120A-B with expected position value along the predefined path. If a difference between the current position value and the expected position value exceeds a predefined threshold, the first controller determines said difference to be the deviation.

Thereafter, based on the deviation, the first controller determines corrective actions to be undertaken at the mobile robot assembly 108. In this regard, the first controller is configured to generate the at least one control signal to modify at least one of: actuator movements of the one or more drive motors, speed of each of the plurality of wheels, steering angles. Hence, the at least one control signal comprises instructions, wherein the instructions are predefined corrective actions encoded within the at least one control signal, that is executed by the traverse controlling unit. The traverse controlling unit interprets these instructions and executes corresponding movements. In this regard, the first controller sends the at least one control signal via wired communication or wireless communication. A technical effect of the guidance system 120A-B is that it ensures that the mobile robot assembly 108 reaches target locations within the storage facility 104, efficiently. Moreover, the guidance system 120A-B ensures that there is precise navigation in an autonomous manner, while providing real-time error correction.

Optionally, the docking arrangement 114 further comprises:
a plurality of first aligner flanges and stoppers mounted on the plurality of first pillars 130A-C, and adjacent to the plurality of first rack gears; and
a plurality of second aligner flanges and stoppers mounted on the plurality of second pillars 136A-C, and adjacent to the plurality of second rack gears;
wherein the plurality of first aligner flanges and stoppers and the plurality of second aligner flanges and stoppers are configured to align position of the pinion gear with respect to the plurality of first rack gears and the plurality of second rack gears by pressing the spring-loaded guide rail and thereby engaging and retaining movement of the pinion gear with the plurality of first rack gears and plurality of second rack gears.

Herein, the term “aligner flange” refers to a mechanical guide mounted on the given pillars (namely, the plurality of first pillars 130A-C and the plurality of second pillars 136A-C), positioned adjacent to the given rack gears (namely, the plurality of first rack gear and the plurality of second rack gear). The aligner flange aids alignment, ensuring the pinion gear remains in proper engagement with the given rack gears. In this regard, the plurality of first aligner flanges are mechanical guides mounted on the plurality of first pillars 130A-C, positioned adjacent to the plurality of first rack gears. In a similar manner, the plurality of second aligner flanges are mechanical guides mounted on the plurality of second pillars 136A-C, positioned adjacent to the plurality of second rack gears. Moreover, the term “stoppers” refers to physical constraints positioned to limit excess movement of the pinion gear and prevent misalignment or disengagement.

In this regard, the plurality of first aligner flanges and the plurality of second aligner flanges and stoppers ensure that the pinion gear engages properly with the corresponding rack gears, maintaining smooth and uninterrupted movement. Herein, when the spring-loaded guide rail is pressed the plurality of first aligner flanges and the plurality of second aligner flanges and stoppers apply a controlled force, ensuring the pinion gear remains engaged with the plurality of first rack gears and the plurality of second rack gears. This prevents unintended disengagement due to vibrations, sudden movements, or load variations. Moreover, the spring-loaded guide rail absorbs shock forces, maintaining a constant engagement force between the pinion gear and the plurality of first rack gears and the plurality of second rack gears. Once the pinion gear is engaged, such alignment mechanism ensures sustained movement along the plurality of first rack gears and the plurality of second rack gears without positional deviations. The engagement is retained even under operational stress, ensuring smooth and controlled traversal of the given pick and drop robot. A technical effect of the aforementioned feature is that it ensures consistent and reliable engagement of the pinion gear with the rack gears, with minimal to no friction and component degradation.

The plurality of first aligner flanges and the plurality of second aligner flanges is made such that a ramp of the plurality of first aligner flanges and the plurality of second aligner flanges can correct the given pick and drop robot in both x (exemplary tolerance of +/−5 units) and y (exemplary tolerance of +/−10 units) directions. In the Y axis (which is parallel to an aisle view), a wheel runs over the ramp (which may be inclined at a predefined angle, for example, such as 10 degrees) and aligns by achieving equilibrium between two opposing springs. In the X axis (which is perpendicular to the aisle view), the wheel rubs onto the slope of the aligner flange and slips to correct for any offset (with a tolerance, wherein the tolerance may be, for example, 2 units). Moreover, rollers of a top plate makes it easier for the given pick and drop robot to move horizontally and vertically.

Throughout the present disclosure, the term “pick and drop robot” refers to a specialized vertically mobile robot designed to retrieve or place the loads 102A-F onto the racking structure 106. Herein, each of the pick and drop robots 110A-B operate in coordination with mobile robot assembly 108. Each of the pick and drop robots 110A-B are equipped with climbing mechanisms. Examples of the climbing mechanisms may include, but are not limited to, a rack-and-pinion drives, a lead screw, and a scissor lift. Moreover, the racking structure 106 comprises guides, rails, or tracked movement systems, to facilitate vertical movement of each of the pick and drop robots 110A-B. Furthermore, the pick and drop robots 110A-B employ sensors for positional accuracy and to ensure precise engagement with the loads 102A-F. Thus, the pick and drop robots 110A-B automates vertical retrieval of the loads 102A-F, thus reducing manual intervention and mechanical complexity. The given pick and drop robot comprises at least one key specification, wherein the at least one key specification comprises at least one of: a motor type, number of motors, motor output torque, motor power, gearbox type, gear ratio, weight of the module, universal coupler 122, a battery.A technical benefit of the pick and drop robots 110A-B is that it enhances load-handling precision, thus reducing the risk of misplacement. Another technical benefit of the pick and drop robots 110A-B is that operational efficiency is improved as the pick and drop robots 110A-B work in parallel.

Optionally, each of the plurality of pick and drop robots 110A-B comprises:
a chassis having a plurality of frame members;
a power source mounted on the chassis;
a plurality of first compliance units and a plurality of second compliance units coupled with the chassis and operable to engage with the plurality of first rack gears and the plurality of second rack gears, respectively;
a power transmission mechanism, operatively coupled to the plurality of first compliance units and the plurality of second compliance units, for providing transmission power to the plurality of first compliance units and a plurality of second compliance units to traverse along the plurality of first rack gears and the plurality of second rack gears, respectively;
a fork mechanism mounted on the chassis and operable to pick and drop the loads 102A-F from the racking structure 106, wherein the fork mechanism has a third end and a fourth end opposite to the third end; and
a second controller, operatively coupled with the power source, the power transmission mechanism and the fork mechanism, for traversing each of the plurality of pick and drop robots 110A-B to a given storage compartment in the storage facility 104 for picking and dropping the loads 102A-F therefrom.

Herein, the term “chassis” refers to a primary structural framework that provides mechanical support and housing for all components of the given pick and drop robot. The chassis serves as a mounting base for all other components, including the power source, compliance units, power transmission mechanism, and fork mechanism. Moreover, the plurality of frame members are individual structural elements that collectively form and reinforce the chassis, ensuring rigidity, durability, and load-bearing capability. Herein, the plurality of frame members are arranged in a structured manner to provide support and stability to the given pick and drop robot. The power source of each of pick and drop robots 110A-B is similar to or different from the power source of the mobile robot assembly 108.

Moreover, the term “compliance unit” refers to a mechanical element that is designed to absorb misalignments, dampen vibrations, and maintain engagement with the plurality of first rack gears and the plurality of second rack gears. In this regard, the compliance unit self-adjusts to maintain a constant meshing force between drive mechanism of the given pick and drop robot and the plurality of first rack gears and the plurality of second rack gears. Beneficially, the compliance unit compensates for mechanical misalignments during traversal. Herein, the plurality of first compliance units engage with the plurality of first rack gears, while the plurality of second compliance units engage with the plurality of second rack gears.

Moreover, the term “power transmission mechanism” refers to a system of gears, motors, shafts, and couplings responsible for transmitting mechanical power to drive the plurality of first compliance units and the plurality of second compliance units. Such mechanical power enables the given pick and drop robot to move vertically along the racking structure 106. In this regard, the power transmission mechanism converts the rotational motion from the one or more drive motors into linear movement, driving the plurality of first compliance units and the plurality of second compliance units along the plurality of first rack gears and the plurality of second rack gears, respectively. A technical benefit of the plurality of first compliance units and a plurality of second compliance units is that they ensure smooth engagement, by preventing sudden jerks or misalignments.

Moreover, the fork mechanism comprises extendable arms that engage with the storage compartments 134A-C and 140A-C to pick up and drop off the loads 102A-F. Herein, the third end and the fourth end define two opposite extremities of the fork mechanism, which ensures balanced handling of the loads 102A-F. In this regard, the fork mechanism extends towards the storage compartment, engages with the load in the storage compartment, and lifts the load from the racking structure 106. After lifting the load from the racking structure 106, the fork mechanism retracts once the load is secured and transports said load to a designated drop-off location within the storage facility 104. A technical benefit of the fork mechanism is that it ensures precise load engagement and release, thus preventing misplacement.

Moreover, the second controller receives operational commands and determines the current location of the given pick and drop robot. The second controller is configured to control traversal along the plurality of first rack gears and the plurality of second rack gears, using the power transmission mechanism. Additionally, the second controller management of the fork mechanism, thus ensuring precise load handling.

A technical benefit of the aforementioned feature is that there is accurate and stable traversal along the plurality of first rack gears and the plurality of second rack gears, while efficiently handling the load with the fork mechanism. Another technical benefit of the aforementioned feature is that there is autonomous operation, reducing reliance on human intervention. Even with the autonomous operation, beneficially, there is high precision that ensures optimal space utilization in the storage facility 104.

Throughout the present disclosure, the term “latch arrangement” refers to a mechanical locking mechanism that secures the pick and drop robots 110A-B onto the racking structure 106, thus ensuring a stable engagement during handling of the loads 102A-F. The latch arrangement 116 engages with predefined slots in the racking structure 106. The latch arrangement 116 could use any one of: an actuated locking mechanism, passive locking mechanism. Beneficially, the latch arrangement 116 prevents unintended movement or detachment of the given pick and drop robot while handling the load. The latch arrangement 116 also ensures that there is precise alignment of the given pick and drop robot with the racking structure 106 for consistent picking or dropping of the loads 102A-F. A technical benefit of the latch arrangement is that it prevents operational failures due to unintended dislodging of the given pick and drop robot.

Throughout the present disclosure, the term “climb arrangement” refers to a mechanical system enabling each of the pick and drop robots 110A-B to ascend or descend along the racking structure 106. The climb arrangement 118 uses any one of: the rack-and-pinion drive, the lead screw, a telescopic lift to move vertically. Moreover, the climb arrangement 118 could coordinate with the sensors and controllers of the given pick and drop robot to maintain accurate positioning of the given pick and drop robot. Beneficially, the climb arrangement 118 enables access to different height levels within the racking structure 106. A technical benefit of the climb arrangement 118 is that it ensures smooth, controlled motion, of each of the pick and drop robots 110A-B, thus preventing mechanical stress on the loads 102A-F.

Optionally, the climb arrangement 118 comprises a first pinion at a first end, and a second pinion at a second end opposite to the first end, wherein the first end of the first pinion is coupled with a bevel gearbox using a universal coupler 122, and the second end of the second pinion is coupled directly with the bevel gearbox.

Herein, the term “pinion” refers to a small gear that meshes with a given rack gear to convert rotational motion into linear motion, facilitating climbing. The term “given rack gear” encompasses at least one from amongst the plurality of first rack gears and at least one from amongst the plurality of second rack gears. The first pinion is positioned at the first end of the climb arrangement 118. The second pinion is positioned at the second end, opposite to the first pinion. The first pinion and second pinion engage with the rack gears, enabling the pick and drop robots 110A-B to traverse vertically along the racking structure 106. In this regard, when the first pinion and the second pinion rotate, they interact with the plurality of first rack gears and the plurality of second rack gears attached to the racking structure 106, thus translating rotational motion into controlled vertical movement. Moreover, simultaneous engagement of both the first pinion and the second pinion ensures balanced climbing of the pick and drop robots 110A-B, thereby reducing a risk of misalignment or tilting.

Moreover, the term “bevel gearbox” refers to a gear mechanism that changes direction of rotational motion, typically at a 90-degree angle. Herein, the bevel gearbox transmits power to the first pinion, thus enabling rotation of the first pinion. The bevel gearbox is driven by a servo motor with electronic brakes. The bevel gearbox receives input torque from the traction arrangement Tand transmits it to the first pinion. Moreover, the term “universal coupler” refers to a mechanical linkage that allows angular misalignment between connected shafts. It ensures smooth power transmission even if the shafts are not perfectly aligned. The universal coupler 122 connects the bevel gearbox to drive shaft of the first pinion, thus accommodating any misalignment that may occur due to movement tolerances. The first pinion is coupled with the bevel gearbox using the universal coupler 122 to compensate for minor misalignments that occur due to structural tolerances in the pick and drop robots 110A-B. This enables smooth transmission of the rotational power. The second pinion is coupled directly with the bevel gearbox, which allows direct transmission of the rotational motion without flexibility. Such coupling of the second pinion with the bevel gearbox provides a rigid, fixed connection, ensuring a constant torque transfer without power losses. Such connections allow for precise synchronization between the two pinions, ensuring they rotate in unison for stable climbing.

A technical effect of the aforementioned feature is that it ensures stable and precise vertical movement, with minimized mechanical stress and misalignment.

Optionally, the traverse controlling unit comprises at least one of:
a camera operatively coupled to the first controller, wherein the camera is operable to capture at least one image of a plurality of reading tags arranged on a floor of the storage facility 104 to determine a position and an orientation of the at least one mobile robot assembly 108 with respect to the storage facility 104;
an ultrasonic sensor operatively coupled to the first controller, wherein the ultrasonic sensor is operable to measure distance to at least one obstacle within the storage facility 104 to determine a position and an orientation of the at least one mobile robot assembly 108 with respect to the storage facility 104;
a light detection and ranging (LIDAR) operatively coupled to the first controller, the LIDAR is operable to emit laser beam for creating a three-dimensional (3D) map to detect and interact with surrounding objects of the at least one mobile robot assembly 108 while traversing.

In this regard, the camera captures at least one image of the plurality of reading tags, wherein each of the plurality of reading tags comprise identifiable visual markers, for example, such as QR codes, barcodes, fiducial markers, and similar. In this regard, each of the plurality of reading tags can be strategically placed to enable accurate positioning without a need for complex global positioning systems (GPS). The first controller is configured to process these at least one image to determine the position and the orientation of the mobile robot assembly 108 with respect to the storage facility 104. Optionally, the first controller employs computer vision algorithms to correct any positional drift of the mobile robot assembly 108 and adjusts the trajectory of the mobile robot assembly 108 accordingly. A technical benefit of camera being operatively coupled to the first controller is that it enables accurate localization of the mobile robot assembly 108 without requiring external tracking infrastructure. Another technical benefit is that it enhances positioning reliability, even in environments with varying lighting conditions.

Moreover, the term “ultrasonic sensor” refers to a proximity detection device that uses high-frequency sound waves to measure the distance between the mobile robot assembly 108 and the at least one obstacle. In this regard, the ultrasonic sensor emits ultrasonic pulses, which reflect off of the at least one obstacle and return to the ultrasonic sensor. Herein, a time taken for the ultrasonic pulses to bounce back is used to calculate the distance between the at least one obstacle and the mobile robot assembly 108. Thereafter, the first controller processes this information to determine the mobile robot assembly's position and orientation relative to a layout of the storage facility 104. A technical effect of the ultrasonic sensor being operatively coupled to the first controller is that said ultrasonic sensor functions effectively in low-light or dusty environments. Another technical effect of the ultrasonic sensor being operatively coupled to the first controller is that it provides real-time obstacle detection, thereby enabling dynamic path correction.

Moreover, the term “LIDAR” refers to a remote sensing technology that emits laser pulses and measures a time-of-flight of reflections of said laser pulses to create a high-resolution three-dimensional (3D) map of the storage facility 104. In this regard, the LIDAR emits laser pulses in multiple directions. The first controller then calculates distances by measuring the time it takes for the laser pulses to return. Thereafter, a detailed 3D point cloud map of surroundings the mobile robot assembly 108 is created, thus enabling precise navigation and obstacle avoidance. A technical effect of the LIDAR being operatively coupled to the first controller is that it provides high-precision mapping with millimeter-level accuracy. Another technical effect of the LIDAR being operatively coupled to the first controller is that it enables autonomous navigation even in environments where plurality of reading tags are not available. Beneficially, the LIDAR allows the mobile robot assembly 108 to detect at least one obstacle that are dynamic, for example, such as workers or moving machinery.

Referring to FIG. 2, there is shown a pinion gear 202 of the power transmission mechanism, in accordance with an embodiment of the present disclosure. Herein, the pinion gear 202 is operatively coupled with the drive shaft (not shown for the sake of clarity).

It may be understood by a person skilled in the art that the FIG. 2 includes a simplified architecture of a pinion gear 202 for sake of clarity, which should not unduly limit the scope of the claims herein. The person skilled in the art will recognize many variations, alternatives, and modifications of embodiments of the present disclosure.

Optionally, the power transmission mechanism comprises:
a pair of motors; and
a pair of bevel gearboxes operatively coupled with the pair of motors, and wherein each of the plurality of compliance units comprises:
a drive shaft operatively coupled with one of the pair of bevel gearboxes;
a pinion gear 202 operatively coupled with the drive shaft;
a spring-loaded guide rail mounted on one of a frame member of the chassis, wherein the spring-loaded guide rail is arranged longitudinally between the third end and the fourth end of the fork mechanism; and
a pair of gear fixators for supporting the pinion gear 202 on the spring loaded guide rail.

Herein, the phrase “pair of motors” indicates that two motors are used, likely for driving both sides of the pick and drop robot. Herein, each motor provides rotational energy to one of the pair of bevel gearboxes. The pair of motors operate in synchronization, ensuring balanced movement and power distribution to the plurality of first compliance units and the plurality of first compliance units. The pair of bevel gearboxes are mechanically linked to the pair of motors, thus allowing efficient power transfer. In this regard, rotational motion from the pair of motors is transferred to the pair of bevel gearboxes, which is then redirect towards the plurality of first compliance units and the plurality of second compliance units. This ensures that the mechanical power is aligned with the racking structure 106, enabling the given pick and drop robot to traverse efficiently.

Moreover, the term “drive shaft” refers to a rotating mechanical component that transfers power from the pair of bevel gearboxes to the pinion gear 202. The drive shaft is mechanically linked to the pair of bevel gearboxes, allowing efficient torque transmission. In this regard, the pair of bevel gearboxes rotates the drive shaft, which in turn rotates the pinion gear 202. The drive shaft ensures uniform torque distribution, preventing mechanical imbalances.

Moreover, the term “pinion gear” refers to a small cogwheel that engages with the plurality of first rack gears and the plurality of second rack gears, facilitating vertical motion of the given pick and drop robot. The pinion gear 202 is mechanically linked to the drive shaft, thus ensuring rotational energy is transferred effectively. In this regard, the drive shaft rotates the pinion gear 202, which then engages with the plurality of first rack gears and the plurality of second rack gears to move the given pick and drop robot along the racking structure 106. The gear teeth interlock with the plurality of first rack gears and the plurality of second rack gears, thus ensuring a stable climbing motion.

Moreover, the term “spring-loaded guide rail” refers to a linear track system with spring mechanisms that provide flexibility and damping. The spring-loaded guide rail is securely attached to the chassis. Herein, spring mechanism of the spring-loaded guide rail compensates for small misalignments, ensuring smooth engagement between the pinion gear 202 and the plurality of first rack gears and the plurality of second rack gears.

Moreover, the term “gear fixator” refers to mechanical brackets or holders that secure the pinion gear 202 in place while allowing controlled movement. Herein, the pair of gear fixators keep the pinion gear 202 aligned with the plurality of first rack gears and the plurality of second rack gears, thus reducing lateral movement.

A technical effect of the aforementioned feature is that it enables smooth and stable traversal along the racking structure 106, with accurate and reliable movement of the pick and drop robot.

Optionally, the system 100 further comprises a fourth sensor for sensing a position of the pinion gear 202 with respect to the plurality of first rack gears and the plurality of second rack gears to allow the power transmission mechanism to operate and allow movement of the pinion gear 202 with respect to the plurality of first rack gears and the plurality of second rack gears.

Herein, the term “fourth sensor” refers to a position-sensing device that detects and determines the real-time position of the pinion gear 202 relative to the plurality of first rack gears and the plurality of second rack gears. The fourth sensor provides feedback for precise control of the power transmission mechanism. The fourth sensor is configured to continuously or periodically detect exact spatial position of the pinion gear 202 along the plurality of first rack gears and the plurality of second rack gears. Beneficially, such detection of the exact spatial position ensures that power is not transmitted erroneously when the pinion gear 202 is in an incorrect position, reducing mechanical strain and potential system failure. Moreover, the pinion gear 202 moves with respect to the plurality of first rack gears and the plurality of second rack gears, which ensures that the pinion gear 202 is in correct engagement with the rack gears before allowing movement. Examples of the fourth sensor may include, but are not limited to, an optical sensor, a magnetic sensor, a capacitive sensor, and an inductive sensing sensor.

A technical effect of the aforementioned feature is that the fourth sensor ensures precise positioning of the pinion gear 202 before power transmission, preventing misalignment, mechanical wear, and operational failures. This enhances automation, improves movement accuracy, and optimizes power efficiency, leading to reliable and efficient robotic navigation in storage systems.

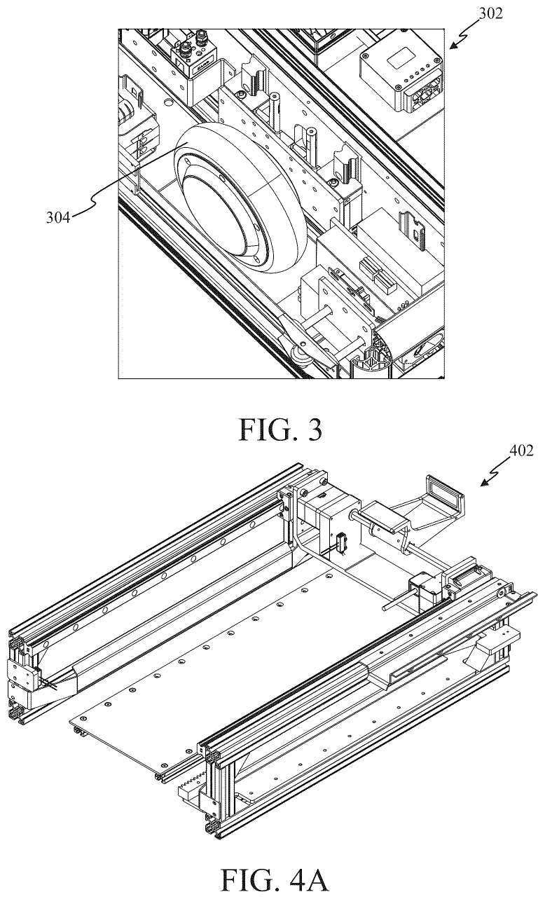

Referring to FIG. 3, there is shown a traction arrangement 302 of mobile robot assembly 108 of FIG. 1A, in accordance with an embodiment of the present disclosure. The traction arrangement 302 has a chassis (not shown for the sake of clarity), a plurality of wheels (depicted as a wheel 304 that is visible in current view) mounted on the chassis, one or more drive motors operatively coupled with the wheel 304, a transmission mechanism for operatively coupling the one or more drive motors with the wheels 304, a suspension mechanism mounted on the chassis, a power source mounted on the chassis and operatively coupled to the one or more drive motors, a first controller (not shown for sake of clarity) for controlling power from the power source to the one or more drive motors of the traction arrangement 302 for traversing the mobile robot assembly 108 to a designated location in the storage facility 104; and a traverse controlling unit (not shown for sake of clarity) operatively coupled to the first controller, wherein said traverse controlling unit is operable to determine and control movement of the mobile robot assembly 108 within the storage facility 104.

It may be understood by a person skilled in the art that the FIG. 3 includes a simplified architecture of a traction arrangement 302 for sake of clarity, which should not unduly limit the scope of the claims herein. The person skilled in the art will recognize many variations, alternatives, and modifications of embodiments of the present disclosure.

Optionally, each of the at least one mobile robot assembly 108 comprises:
a traction arrangement 302 having:
   a chassis,
   a plurality of wheels 304 mounted on the chassis,
   one or more drive motors operatively coupled with the plurality of wheels 304,
   a transmission mechanism for operatively coupling the one or more drive motors with the plurality of wheels 304, and
   and a suspension mechanism mounted on the chassis;
a power source mounted on the chassis and operatively coupled to the one or more drive motors;
a first controller for controlling power from the power source to the one or more drive motors of the traction arrangement 302 for traversing the at least one mobile robot assembly 108 to a designated location in the storage facility 104; and
a traverse controlling unit operatively coupled to the first controller, wherein said traverse controlling unit is operable to determine and control movement of the at least one mobile robot assembly 108 within the storage facility 104.

In this regard, components of the mobile robot assembly 108 is mentioned, wherein such components ensure that the mobile robot assembly 108 has traction, power, control, and navigation capabilities for traversing the storage facility 104. Herein, the term “traction arrangement” refers to a mechanical and electromechanical subsystem that is responsible for propelling, maneuvering, and stabilizing the mobile robot assembly 108. The term “chassis” refers to a structural frame that provides support, stability, and mounting surfaces for all the components of the mobile robot assembly 108. Herein, the chassis accommodates the plurality of wheels 304, the one or more drive motors, the transmission mechanism, the suspension system, the power source, and the first controller. Hence, the chassis houses all mechanical, electrical, and electronic subsystems. Such housing ensures structural integrity, allowing the mobile robot assembly 108 to withstand operational forces. Moreover, the chassis could provide mounting points for critical components, for example, such as the one or more drive motors, the first controller, and similar.

Moreover, the plurality of wheels 304 enable the movement of the mobile robot assembly 108 within the storage facility 104. In other words, the plurality of wheels 304 enable the mobile robot assembly 108 to navigate through storage aisles. The plurality of wheels 304 could be any one of: fixed-directional, omni-directional, independently steerable.

Moreover, the term “drive motor” refers to electric actuators that responsible for generating torque to rotate each of the plurality of wheels 304. Herein, the direct current (DC) motors receive electrical energy from the power source. Subsequently, the electrical energy is converted into mechanical motion. Resultantly, each of the plurality of wheels 304 rotate proportionally to a required speed and direction of the mobile robot assembly 108. Beneficially, the one or more drive motors provide a controlled movement with dynamic speed adjustment of the mobile robot assembly 108. Examples of the one or more driver motors may include, but are not limited to, brushed direct current (DC) motors, brushless DC motors, servo motors, and stepper motors.

Moreover, the term “transmission mechanism” refers to a power transfer system that regulates the speed and torque between the one or more drive motors and the plurality of wheels 304. In this regard, the transmission mechanism transfers rotational energy from the one or more drive motors to the plurality of wheels 304. The transmission mechanism then adjusts torque-speed ratios, and provides mechanical leverage of/to the mobile robot assembly 108. Beneficially, the transmission mechanism allows variable speed control of the mobile robot assembly 108, thus ensuring smooth movement transitions.

Moreover, the term “suspension mechanism” refers to a shock-absorbing system that stabilizes the mobile robot assembly 108 while traversing uneven surfaces. The suspension mechanism could include any one of: a spring, a damper, an air cushion, to mitigate any impact force on the mobile robot assembly 108. The suspension mechanism absorbs mechanical vibrations, enhances traction, and ensures weight distribution on the chassis. Such absorption of the mechanical vibrations prevents excessive strain on electronic and mechanical components. The traction ensures continuous contact between the plurality of wheels 304 and ground of the storage facility 104. The weight distribution on the chassis ensures that the mobile robot assembly 108 does not tilt or suffer from any imbalance.

Moreover, the power source supplies electrical energy to the one or more drive motors and other electronic components. The power source could be a rechargeable power source (for example, such as a lithium-ion battery, a lead-acid battery, a supercapacitor, and similar) or a wired power source. The power source stores and supplies consistent electrical power to the components of the mobile robot assembly 108.

A given controller (namely, the first controller, a second controller) could be implemented as any one of: a microprocessor, a microcontroller, or a processor. As an example, the first controller could be implemented as a central computing unit based on existing Advanced RISC Machine (ARM®) chip. As another example, the second controller could be implemented as an application-specific integrated circuit (ASIC) chip or a reduced instruction set computer (RISC) chip. Herein, the first controller receives power input from the power source. The first controller is configured to process navigation commands to determine movement parameters of the mobile robot assembly 108. Furthermore, the first controller is configured to control actuation of the one or more drive motors, thus ensuring precise traversal to target locations within the storage facility 104.

Moreover, the “traverse controlling unit” refers to a navigation module that governs movement planning and execution of the mobile robot assembly 108. In other words, the traverse controlling unit is an intelligent system that is responsible for decision-making and movement optimization of the mobile robot assembly 108 within the storage facility 104. In this regard, the traverse controlling unit is configured to determine real-time position of the mobile robot assembly 108 using onboard sensors (e.g., LIDAR, cameras, or ultrasonic sensors). The traverse controlling unit is then configured to calculate movement paths based on designated waypoints or pre-programmed routes. Consequently, the one or more drive motors are activated and the speed of the plurality of wheels 304 are controlled to ensure smooth traversal.

A technical benefit of the aforementioned components is that they enhance automation by ensuring precise, reliable movement of the mobile robot assembly 108, thus improving operational efficiency, and reducing manual intervention. Another technical benefit of the aforementioned components is that they support intelligent navigation, while optimizing energy utilization.

Optionally, the docking arrangement 114 comprises at least two discs with a predefined gap between each other, wherein each of the plurality of pick and drop robots comprises a corresponding guide rail and plate that is arranged in said predefined gap to operatively mount the pick and drop robot on the docking arrangement 114 of the mobile robot assembly 108. Herein, the at least two discs are structural rotary or stationary elements that act as guiding and supporting components within the docking arrangement 114. The at least two discs provides a stable docking interface which ensures that the given pick and drop robot remains securely attached during transportation. Moreover, the term “predefined gap” refers to a precisely determined spacing between the at least two discs, thus allowing correct placement and secure attachment of the pick and drop robots 110A-B. Furthermore, the predefined gap ensures that the robot aligns accurately with the docking arrangement 114 without excessive clearance or tightness, which could cause operational inefficiencies. Additionally, the predefined gap between the at least two discs acts as a receptacle, which accommodates the corresponding guide rail and the plate of the given pick and drop robot. Hence, when the given pick and drop robot is lowered or slid into the docking arrangement 114, it aligns within the predefined gap, thus ensuring correct positioning.

Moreover, the term “guide rail” refers to a structural element that ensures controlled movement and alignment of the given pick and drop robot during docking and undocking. Herein, the guide rail slides into the predefined gap, ensuring that the given pick and drop robot enters the docking arrangement 114 smoothly and aligns properly. The plate acts as a mounting surface that helps the given pick and drop robot maintain stability while docked. Herein, the plate provides a stable contact surface, ensuring that the given pick and drop robot remains rigidly mounted without unwanted movement. Moreover, the combination of the guide rail and plate ensures that the given pick and drop robot is securely held in place on the mobile robot assembly 108, preventing misalignment or detachment during transportation. In other words, when latching is initiated the docking arrangement 114 releases a docking shaft and the pick and drop robot aligns properly on casters. Once the plate is fully inserted into the docking arrangement 114, the given pick and drop robot is securely mounted, thus allowing the mobile robot assembly 108 to transport said given pick and drop robot safely within the storage facility 104.

A technical effect of such configuration of the docking arrangement 114 is that it allows the mobile robot assembly 108 to safely transport the pick and drop robots 110A-B, thereby enabling efficient load handling in the storage facility 104.

Optionally, each of the plurality of pick and drop robots 110A-B further comprises a load cell to measure a weight of a given load picked by the fork mechanism, wherein the fork mechanism is arranged on the load cell.

Herein, the term “load cell” refers to a sensor that is designed to measure the weight of the given load. The load cell converts applied mechanical load into an electrical signal, which is processed by the second controller. Examples of the load cell may include, but are not limited to, a strain gauge-based load cell, a piezoelectric load cell, and similar. The load cell sends real-time weight data to the second controller, ensuring accurate record-keeping and process optimization. The controller is configured to compare measured weight with predefined values to detect at least one of: overloading, misplacement, missing loads 102A-F. The load cell is structurally integrated beneath the fork mechanism, allowing direct measurement of any load applied to the forks. The load cell provides direct load measurement, wherein when the fork mechanism engages with the load, the entire force is transmitted through the load cell. Moreover, it is determined whether the load is stable or unevenly positioned. If the load exceeds weight limits or is improperly positioned, the second controller is configured to modify speed, trajectory, or lifting mechanism, of the pick and drop robot. A technical effect of the aforementioned feature is that prevents overloading and structural failures, ensuring robot longevity. Another technical effect of the aforementioned feature is that there is adjustment of movement, speed, and positioning, of the pick and drop robot based on real-time weight data.

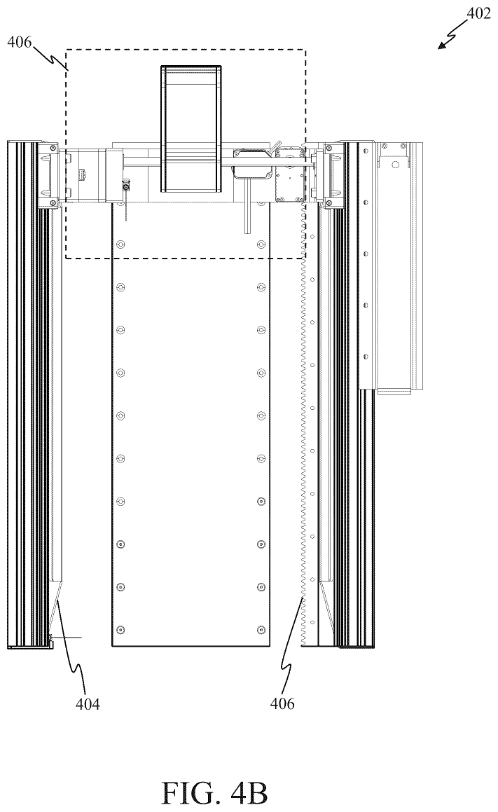

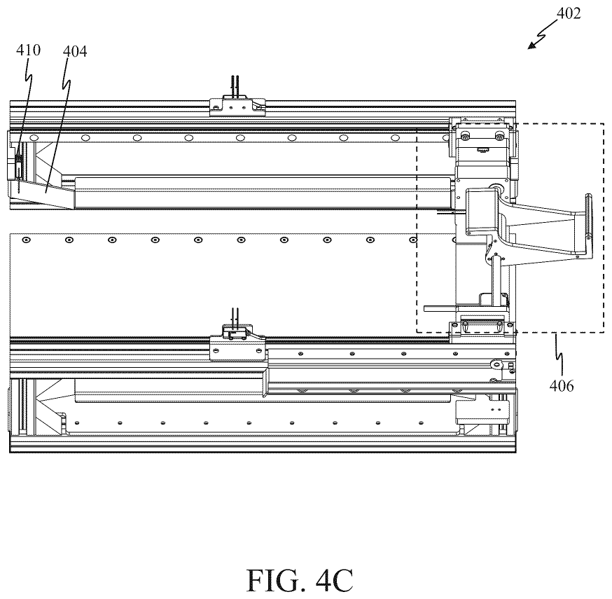

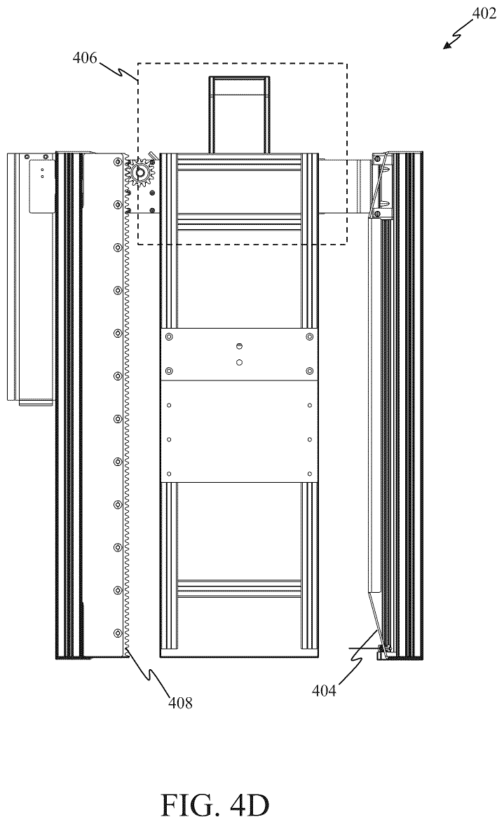

Referring to FIGS. 4A, 4B, 4C, and 4D, there are shown schematic illustrations, in different views, of the fork mechanism 402, in accordance with an embodiment of the present disclosure. In FIG. 4A, there is shown an isometric view of the fork mechanism 402. In FIG. 4B, there is shown a top view of the fork mechanism 402. In FIG. 4C, there is shown a top perspective view of the fork mechanism 402. In FIG. 4D, there is shown a back view of the fork mechanism 402. In FIGS. 4B and 4C, there are shown a horizontal aligner 404, a gantry 406. In FIG. 4B, there is also shown a rack and pinion 408. In FIG. 4C, there is shown at least two proximity sensors (depicted as a proximity sensor 410, that is visible in the FIG. 4C). In FIG. 4D, there is shown horizontal aligner 404, a gantry 406, and the rack and pinion 408.

It may be understood by a person skilled in the art that the FIGS. 4A-D includes a simplified architecture of a fork mechanism 402 for sake of clarity, which should not unduly limit the scope of the claims herein. The person skilled in the art will recognize many variations, alternatives, and modifications of embodiments of the present disclosure.

Optionally, the fork mechanism 402 comprises:
a grappling hook mechanism configured to pull the load and traverse along the spring-loaded guide rail;
at least two receiving elements arranged longitudinally on either side of the spring-loaded guide rail between the third and the fourth end, to receive the loads 102A-F when pulled by the grappling hook mechanism; and
at least two proximity sensors 410 arranged on the third end and the fourth end of the fork mechanism 402, wherein the at least two proximity sensors 410 emulate safety endstops for the grappling hook mechanism when traversing along the spring-loaded guide rail.

Herein, the term “grappling hook mechanism” refers to a mechanical grabbing device designed to latch onto and secure the load. The grappling hook mechanism is configured to pull the load, indicating that said grappling hook mechanism actively engages with the loads 102A-F and moves said loads 102A-F towards a designated location. The grappling hook mechanism moves linearly along the spring-loaded guide rail, thus ensuring smooth and controlled motion. In this regard, the grappling hook mechanism extends towards the load and engages with it using a hooking action. Once the load is secured, the grappling hook mechanism retracts, pulling the load towards designated receiving position. The spring-loaded guide rail facilitates smooth movement by compensating for minor misalignments and ensuring consistent traversal. A technical benefit of the grappling hook mechanism is that it provide a secure and reliable gripping solution for handling various types of loads 102A-F, thus ensuring secure engagement with the load, preventing accidental drops.

Moreover, the term “receiving element” refers to a load-supporting component that holds the load once it is pulled by the grappling hook mechanism. The at least two receiving elements are aligned along the length of the spring-loaded guide rail, positioned on both sides to provide stable support. The at least two receiving elements are located between the two terminal points, i.e., the third end and the fourth end of the fork mechanism 402. In this regard, when the grappling hook mechanism pulls the load, the at least two receiving elements provide a stable surface for the load to rest upon. The at least two receiving elements support a weight of the load once it is pulled. A technical benefit of the at least two receiving elements is that ensures efficient and precise positioning of the retrieved load, thus reducing a risk of accidental falls.

Moreover, the term “proximity sensor” refers to non-contact sensing devices used to detect the presence of the load, which may be overhanging from the racking structure 106. The at least two proximity sensors 410 are positioned at the third end and the fourth end of the fork mechanism 402, which means that they are placed at both terminal points of the fork mechanism 402 to monitor traversal limits. In this regard, the at least two proximity sensors 410 function as virtual endstops to ensure controlled traversal. Herein, as the grappling hook mechanism traverses along the spring-loaded guide rail, the at least two proximity sensors 410 detect position of said grappling hook mechanism. When the grappling hook mechanism reaches either end of the spring-loaded guide rail, the at least two proximity sensors 410 act as virtual endstops, triggering a control response to prevent further movement. this prevents the grappling hook mechanism from exceeding its traversal limits, ensuring safe and controlled operation. Thus, the at least two proximity sensors 410 detect the boundaries of movement, preventing mechanical overextension, thus ensuring that the grappling hook mechanism does not collide with other components.

A technical effect of the aforementioned feature is that there are improved safety measures, reducing mechanical failures and wear. Another technical effect of the aforementioned feature is that there is enhanced precision, due to minimization of misalignment and mishandling of the loads 102A-F.

Optionally, the fork mechanism 402 comprises a gantry and a horizontal aligner 404. Herein, when the pick and drop robot reaches a picking location of the load, the gantry moves forward to pick the load. The horizontal aligner 404 helps in guiding the load onto the fork mechanism 402, to account for any misaligned placement or picking.

Optionally, the fork mechanism 402 further comprises a third sensor that is configured to identify overhanging of the load from a storage compartment of the racking structure 106, in a path of the pick and drop robot, when the pick and drop robot is traversing vertically along the racking structure 106.

Herein, the third sensor is configured to detect load misalignment, specifically when a portion of the load extends beyond a designated storage boundary. The third sensor scans the storage compartment to determine whether any portion of the load is protruding. The third sensor transmits real-time data to the second controller of the pick-and-drop robot, which evaluates the degree of overhang based on predefined safety limits. If the overhang exceeds a permissible threshold, the second controller may trigger alerts or generate control signals to adjust retrieval procedures. Moreover, the third sensor also monitors navigation path of the pick and drop robot to check for overhanging obstacles. If an overhanging load is detected, the second controller of the pick and drop robot is configured to modify its trajectory. Thus, sensor data from the third sensor feeds into the path planning system of the pick and drop robot, thereby allowing real-time adjustments to prevent collisions. Moreover, the third sensor also actively scans for overhanging loads 102A-F above and below the vertical movement of the pick and drop robot. Such scanning is used to determine whether an overhanging load poses a clearance risk during vertical ascent or descent of the pick and drop robot. If an obstruction is detected, the pick and drop robot may pause, adjust its path, or issue a warning. Such detection of the obstruction prevents load interference with the racking structure 106 during vertical motion of the pick and drop robot.

A technical benefit of third sensor is that it prevents collision risks by identifying potential obstructions before engaging with the storage compartment. This also enhances load stability by ensuring that improperly stored loads 102A-F do not cause retrieval failures.

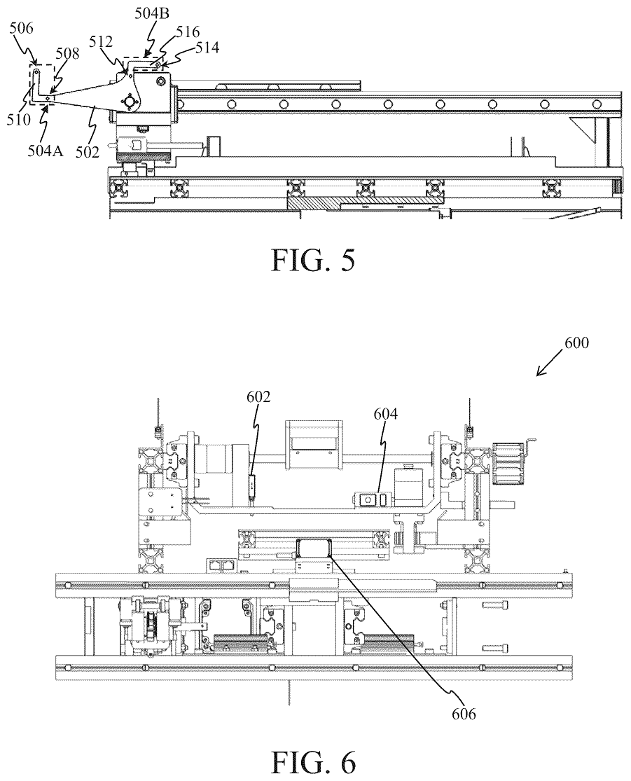

Referring to FIG. 5, there is shown a grappling hook mechanism 502, in accordance with an embodiment of the present disclosure. In FIG. 5, the grappling hook mechanism 502 is comprised in the fork mechanism 402 of FIG. 4A. In FIG. 5A, the grappling hook mechanism 502 comprises a first hook element 504A having a fifth end 506 and a sixth end 508 opposite to the fifth end 506, wherein the fifth end 506 of the first hook element 504A has a first extended element 510 for pulling the load from a storage compartment in the racking structure onto the pick and drop robot till a first predefined endstop, said first hook element 504A has a first predefined length from the fifth end 506 to the sixth end 508, and a second hook element 504B having a seventh end 512 and an eighth end 514 opposite to the seventh end 512, wherein the eighth end 514 of the second hook element 504B has a second extended element 516 for pulling the load till a second predefined endstop of at least two receiving elements, said second hook element 504B has a second predefined length from the seventh end 512 to the eighth end 514, wherein the second predefined length is lesser than the first predefined length, and wherein the sixth end 508 of the first hook element 504A is joined perpendicularly with the seventh end 512 of the second hook element 504B.

It may be understood by a person skilled in the art that the FIG. 5 includes a simplified architecture of a grappling hook mechanism 502 for sake of clarity, which should not unduly limit the scope of the claims herein. The person skilled in the art will recognize many variations, alternatives, and modifications of embodiments of the present disclosure.

Optionally, the grappling hook mechanism 502 comprises:
a first hook element 504A having a fifth end 506 and a sixth end 508 opposite to the fifth end 506, wherein the fifth end 506 of the first hook element 504A has a first extended element 510 for pulling the load from a storage compartment in the racking structure onto the pick and drop robot till a first predefined endstop, said first hook element 504A has a first predefined length from the fifth end 506 to the sixth end 508; and
a second hook element 504B having a seventh end 512 and an eighth end 514 opposite to the seventh end 512, wherein the eighth end 514 of the second hook element 504B has a second extended element 516 for pulling the load till a second predefined endstop of at least two receiving elements, said second hook element 504B has a second predefined length from the seventh end 512 to the eighth end 514, wherein the second predefined length is lesser than the first predefined length, and wherein the sixth end 508 of the first hook element 504A is joined perpendicularly with the seventh end 512 of the second hook element 504B.
a motor that is configured to rotate between the first hook element 504A and the second hook element 504B.

Herein, the first hook element 504A is a rigid structure with two distinct ends, the fifth end 506 and the sixth end 508. The fifth end 506 is a front-facing end, which actively interacts with the load. The sixth end 508 is a rear end, where the first hook element 504A connects to the second hook element 504B. In this regard, the fifth end 506 of the first hook element 504A engages with the load. The first hook element 504A extends and retracts, pulling the load from the storage compartment. The sixth end 508 is joined perpendicularly with the second hook element 504B, allowing a dual-stage engagement for load handling. The first hook element 504A provides a primary engagement structure for gripping the load.

Moreover, the term “extended element” refers to an additional gripping section. The first extended element 510 is an additional gripping section at the fifth end 506 of the first hook element 504A, and second extended element 516 is an additional gripping section at the seventh end 512 of the first hook element 504A. The first extended element 510 and the second extended element 516 function as a load-pulling extension, ensuring secure interaction with the load. In this regard, the first extended element 510 makes initial contact with the load, and then exerts pulling force, ensuring smooth load displacement from the storage compartment. The load is moved until it reaches the first predefined endstop, thus preventing overshooting. Once the load has been pulled by the first hook element 504A, the second hook element 504B takes over. The second extended element 516 ensures final positioning on the receiving platform.

Moreover, the first predefined length refers to the measured extension of the first hook element 504A. The second predefined length is the total length of the second hook element 504B. The second predefined length is shorter than the first predefined length, indicating a staggered gripping mechanism.

Moreover, the sixth end 508 of the first hook element 504A is joined perpendicularly with the seventh end 512 of the second hook element 504B, thus forming a jointed gripping structure. Such jointed gripping structure ensures stable two-stage load transfer, thus optimizing load retrieval.

In this regard, the motor controls the rotational movement, ensuring coordinated gripping action between both the first hook element 504A and the second hook element 504B.

Optionally, the grappling hook mechanism 502 further comprises:
a first sensor arranged on the first hook element 504A; and
a second sensor arranged on the second hook element 504B,
   wherein the first sensor and the second sensor are configured to determine at least one of: a position of the load on the fork mechanism 402, a distance of the load from the fifth end 506 of the first hook element 504A and/or the eighth end 514 of the second hook element 504B.

Herein, the first sensor is configured to monitor position, movement, and alignment of the load. Moreover, the first sensor is configured to detects whether the load is properly engaged. The first sensor then provides feedback to the second controller, enabling real-time adjustments. Similarly, the second sensor monitors load positioning on the second hook element 504B. The position of the load on the fork mechanism 402 is determined to ensure precise tracking, preventing misplacement. The distance of the load from the fifth end 506 of the first hook element 504A and/or the eighth end 514 of the second hook element 504B is determined to provide real-time distance measurements, thus optimizing positioning control.

A technical benefit of the aforementioned feature is that improves accuracy by dynamically adjusting positions of the first hook element 504A and the second hook element 504B.

Referring to FIG. 6, shows a schematic illustration of a pick and drop robot 600, in accordance with an embodiment of the present disclosure. The pick and drop robot 600 comprises a fork mechanism that comprises a grappling hook mechanism. The grappling hook mechanism comprises a first sensor 602 and a second sensor 604. The fork mechanism further comprises a third sensor 606. The first sensor 602 and a second sensor 604 are configured to identify overhanging of any load from the first rack or the second rack, in a path of motion of the pick and drop robot 600. The third sensor 606 is configured to detect the load. Moreover, the third sensor 606 also acts as a reductant safety to avoid the grappling hook mechanism from colliding with any object.

It may be understood by a person skilled in the art that the FIG. 6 includes a simplified architecture of a pick and drop robot 600 for sake of clarity, which should not unduly limit the scope of the claims herein. The person skilled in the art will recognize many variations, alternatives, and modifications of embodiments of the present disclosure.

Advantageously, the system 100 is autonomously navigable, wherein installation in storage facilities is not required, making the system 100 is cost-effective. A throughput (i.e., number of storage tasks and retrieval tasks) of the aforementioned system 100 is flexible due to construction and design of the at least one mobile robot assembly 108 and the pick and drop robots 110A-B, flexible functionality of the system 100, flexible range of movement of the mobile robot assembly 108 and the pick and drop robots 110A-B, and the like. Moreover, the system 100 is designed in such a manner that the mobile robot assembly 108 can autonomously navigate within the storage facility, while the pick and drop robots 110A-B performs storage/retrieval tasks. Moreover, a single mobile robot assembly can be used for the multiple pick and drop robots, thus saving on time resources.

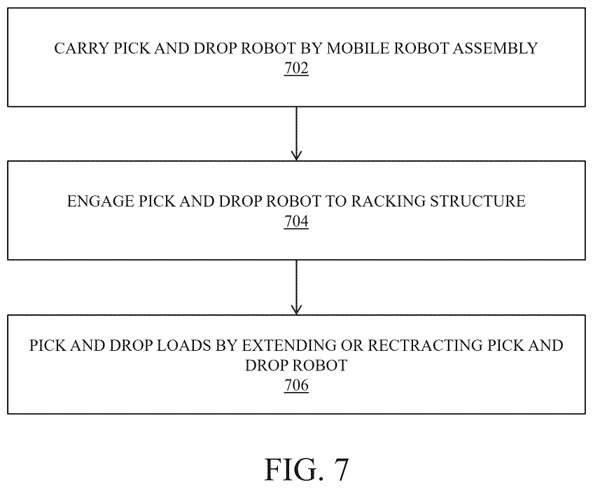

Referring to FIG. 7, illustrated are steps of a method for managing loads in a storage facility, in accordance with an embodiment of the present disclosure. At step 702, a pick and drop robot is carried from amongst a plurality of pick and drop robots by at least one mobile robot assembly that is operable to traverse within a storage facility, wherein the pick and drop robot is operatively mounted on the docking arrangement of said at least one mobile robot assembly. At step 704, when the at least one mobile robot assembly is at a first predefined distance from a racking structure, the pick and drop robot is engaged to the racking structure via a latch arrangement of the pick and drop robot. At step 706, when the pick and drop robot is engaged with the racking structure, the pick and drop robot extends or retracts along a length of the racking structure, via a climb arrangement, for picking and dropping the loads from the racking structure.

The aforementioned steps are only illustrative and other alternatives can also be provided where one or more steps are added, one or more steps are removed, or one or more steps are provided in a different sequence without departing from the scope of the claims herein.

The present disclosure also relates to the aforementioned second aspect as described above. Various embodiments and variants disclosed above, with respect to the aforementioned first aspect, apply mutatis mutandis to the aforementioned second aspect.

What is claimed is:

1. A system for managing loads in a storage facility, the system comprising:
a racking structure configured to store the loads;
at least one mobile robot assembly operable to traverse within a storage facility, each of the at least one mobile robot assembly comprising:
a mobile robot; and
a docking arrangement; and
a plurality of pick and drop robots operable to traverse along a height of the storage facility for picking and dropping the loads from the racking structure, each of the pick and drop robots comprising:
a latch arrangement; and
a climb arrangement,
wherein the at least one mobile robot assembly is operable to carry a pick and drop robot from amongst the plurality of pick and drop robots, the pick and drop robot being operatively mounted on the docking arrangement of the at least one mobile robot assembly, wherein when the at least one mobile robot assembly is at a first predefined distance from the racking structure, the pick and drop robot engages itself to the racking structure via the latch arrangement, and the climb arrangement is configured to extend or retract vertically along a length of the racking structure, for picking and dropping the loads from the racking structure upon engagement with the racking structure.

2. The system of claim 1, wherein the racking structure comprises:
a first rack comprising:
a plurality of first pillars that are arranged in a rectangular configuration to form a storage space, and
a plurality of first plates mounted between the plurality of first pillars to form storage compartments in the storage space, wherein the plurality of first plates are configured to support the loads for the storage thereof, and wherein each of the plurality of first plates are stacked on top of each other at a second predefined distance from each other; and
a second rack comprising:
a plurality of second pillars that are arranged in rectangular configuration to form another storage space, and
a plurality of second plates mounted between the plurality of second pillars to form storage compartments in the another storage space, the plurality of second plates are configured to support the loads for the storage thereof, and wherein each of the plurality of second plates are stacked on top of each other at a third predefined distance from each other;
wherein at least two first pillars from amongst the plurality of first pillars of the first rack that face towards corresponding at least two second pillars from amongst the plurality of second pillars of the second rack, are arranged at a predefined distance from each other to form aisles for the at least one mobile robot assembly to traverse and carry the pick and drop robot therealong.

3. The system of claim 2, wherein the racking structure further comprises:
a plurality of first rack gears coupled to the plurality of first pillars of the first rack; and
a plurality of second rack gears coupled to the plurality of second pillars of the second rack,
wherein the plurality of first rack gears and the plurality of second rack gears form paths for the plurality of pick and drop robots to traverse vertically along the racking structure.

4. The system of claim 1, wherein each of the at least one mobile robot assembly comprises:
a traction arrangement having:
a chassis,
a plurality of wheels mounted on the chassis,
one or more drive motors operatively coupled with the plurality of wheels,
a transmission mechanism for operatively coupling the one or more drive motors with the plurality of wheels;
a suspension mechanism mounted on the chassis;
a power source mounted on the chassis and operatively coupled to the one or more drive motors;
a first controller for controlling power from the power source to the one or more drive motors of the traction arrangement for traversing the at least one mobile robot assembly to a designated location in the storage facility; and
a traverse controlling unit operatively coupled to the first controller, wherein said traverse controlling unit is operable to determine and control movement of the at least one mobile robot assembly within the storage facility.

5. The system of claim 4, wherein the traverse controlling unit comprises at least one of:
a camera operatively coupled to the first controller, wherein the camera is operable to capture at least one image of a plurality of reading tags arranged on a floor of the storage facility to determine a position and an orientation of the at least one mobile robot assembly with respect to the storage facility;
an ultrasonic sensor operatively coupled to the first controller, wherein the ultrasonic sensor is operable to measure distance to at least one obstacle within the storage facility to determine a position and an orientation of the at least one mobile robot assembly with respect to the storage facility;
a light detection and ranging (LIDAR) operatively coupled to the first controller, the LIDAR is operable to emit laser beam for creating a three-dimensional (3D) map to detect and interact with surrounding objects of the at least one mobile robot assembly while traversing.

6. The system of claim 4, wherein the at least one mobile robot assembly further comprises a guidance system that is operatively coupled with the first controller, wherein the first controller is configured to:
receive input from the guidance system, wherein the input comprises position values of the at least one mobile robot assembly;
process the input to determine any deviation of the at least one mobile robot assembly from a predefined path;
when it is determined that there is a deviation of the at least one mobile robot assembly from a predefined path, generate and send at least one control signal to keep the at least one mobile robot assembly in the predefined path, based on the deviation, wherein the at least one control signal comprises instructions for keeping the at least one mobile robot assembly in the predefined path; and
transmit the at least one control signal to the traverse controlling unit to execute the instructions to keep the at least one mobile robot assembly in the predefined path.

7. The system of claim 1, wherein the climb arrangement comprises a first pinion at a first end, and a second pinion at a second end opposite to the first end, wherein the first end of the first pinion is coupled with a bevel gearbox using a universal coupler, and the second end of the second pinion is coupled directly with the bevel gearbox.

8. The system of claim 1, wherein the docking arrangement comprises at least two discs with a predefined gap between each other, wherein each of the plurality of pick and drop robots comprises a corresponding guide rail and plate that is arranged in said predefined gap to operatively mount the pick and drop robot on the docking arrangement of the at least one mobile robot assembly.

9. The system of claim 1, wherein each of the plurality of pick and drop robots comprises:
a chassis having a plurality of frame members;
a power source mounted on the chassis;
a plurality of first compliance units and a plurality of second compliance units coupled with the chassis and operable to engage with the plurality of first rack gears and the plurality of second rack gears, respectively;
a power transmission mechanism, operatively coupled to the plurality of first compliance units and the plurality of second compliance units, for providing transmission power to the plurality of first compliance units and a plurality of second compliance units to traverse along the plurality of first rack gears and the plurality of second rack gears, respectively;
a fork mechanism mounted on the chassis and operable to pick and drop the loads from the racking structure, wherein the fork mechanism has a third end and a fourth end opposite to the third end; and
a second controller, operatively coupled with the power source, the power transmission mechanism and the fork mechanism, for traversing each of the plurality of pick and drop robots to a given storage compartment in the storage facility for picking and dropping the loads therefrom.

10. The system of claim 9, wherein the power transmission mechanism comprises:
a pair of motors; and
a pair of bevel gearboxes operatively coupled with the pair of motors, and wherein each of the plurality of compliance units comprises:
a drive shaft operatively coupled with one of the pair of bevel gearboxes;
a pinion gear operatively coupled with the drive shaft;
a spring-loaded guide rail mounted on one of a frame member of the chassis, wherein the spring-loaded guide rail is arranged longitudinally between the third end and the fourth end of the fork mechanism; and
a pair of gear fixator for supporting the pinion gear on the spring loaded guide rail.

11. The system of claim 10, wherein the fork mechanism comprises:
a grappling hook mechanism configured to pull the load and traverse along the spring-loaded guide rail;
at least two receiving elements arranged longitudinally on either side of the spring-loaded guide rail between the third and the fourth end, to receive the loads when pulled by the grappling hook mechanism; and
at least two proximity sensors arranged on the third end and the fourth end of the fork mechanism, wherein the at least two proximity sensors emulate safety endstops for the grappling hook mechanism when traversing along the spring-loaded guide rail.

12. The system of claim 11, wherein the grappling hook mechanism comprises:
a first hook element having a fifth end and a sixth end opposite to the fifth end, wherein the fifth end of the first hook element has a first extended element for pulling the load from a storage compartment in the racking structure onto the pick and drop robot till a first predefined endstop, said first hook element has a first predefined length from the fifth end to the sixth end; and
a second hook element having a seventh end and an eighth end opposite to the seventh end, wherein the eighth end of the second hook element has a second extended element for pulling the load till a second predefined endstop of at least two receiving elements, said second hook element has a second predefined length from the seventh end to the eighth end, wherein the second predefined length is lesser than the first predefined length, and wherein the sixth end of the first hook element is joined perpendicularly with the seventh end of the second hook element.
a motor that is configured to rotate between the first hook element and the second hook element.

13. The system of claim 12, wherein the grappling hook mechanism further comprises:
a first sensor arranged on the first hook element; and
a second sensor arranged on the second hook element, wherein the first sensor and the second sensor are configured to determine at least one of: a position of the load on the fork mechanism, a distance of the load from the fifth end of the first hook element and/or the eighth end of the second hook element.

14. The system of claim 9, wherein the fork mechanism further comprises a third sensor that is configured to identify overhanging of the load from a storage compartment of the racking structure, in a path of the pick and drop robot, when the pick and drop robot is traversing vertically along the racking structure.

15. The system of claim 9, wherein each of the plurality of pick and drop robots further comprises a load cell to measure a weight of a given load picked by the fork mechanism, wherein the fork mechanism is arranged on the load cell.

16. The system of claim 10, wherein the docking arrangement further comprises:
a plurality of first aligner flanges and stoppers mounted on the plurality of first pillars, and adjacent to the plurality of first rack gears; and
a plurality of second aligner flanges and stoppers mounted on the plurality of second pillars, and adjacent to the plurality of second rack gears;
wherein the plurality of first aligner flanges and stoppers and the plurality of second aligner flanges and stoppers are configured to align position of the pinion gear with respect to the plurality of first rack gears and the plurality of second rack gears by pressing the spring-loaded guide rail and thereby engaging and retaining movement of the pinion gear with the plurality of first rack gears and plurality of second rack gears.

17. The system of claim 16, further comprising a fourth sensor for sensing a position of the pinion gear with respect to the plurality of first rack gears and the plurality of second rack gears to allow the power transmission mechanism to operate and allow movement of the pinion gear with respect to the plurality of first rack gears and the plurality of second rack gears.

18. A method for managing loads in a storage facility, the method comprising:
carrying a pick and drop robot from amongst a plurality of pick and drop robots by at least one mobile robot assembly that is operable to traverse within a storage facility, wherein the pick and drop robot is operatively mounted on a docking arrangement of said at least one mobile robot assembly;
when the at least one mobile robot assembly is at a first predefined distance from a racking structure, engaging the pick and drop robot to the racking structure via a latch arrangement of the pick and drop robot; and
when the pick and drop robot is engaged with the racking structure, extending or retracting the pick and drop robot along a length of the racking structure, via a climb arrangement, for picking and dropping the loads from the racking structure.
